(19) United States
(12) Patent Application Publication
(10) Pub. No.: US 2025/0152475 A1
(43) Pub. Date: May 15, 2025

(54) MEDICATION SUPPORT APPARATUS

(71) Applicants: Youhei Niitsuma, Kanagawa (JP); Hirotaka Hayashi, Kanagawa (JP); Yoshihide Sugiyama, Kanagawa (JP); Hiroshi Fujie, Kanagawa (JP); Manabu Yamanaka, Kanagawa (JP); Takato Mochizuki, Kanagawa (JP); Yu Yamaya, Kanagawa (JP); Sachika Tashiro, Kanagawa (JP)

(72) Inventors: Youhei Niitsuma, Kanagawa (JP); Hirotaka Hayashi, Kanagawa (JP); Yoshihide Sugiyama, Kanagawa (JP); Hiroshi Fujie, Kanagawa (JP); Manabu Yamanaka, Kanagawa (JP); Takato Mochizuki, Kanagawa (JP); Yu Yamaya, Kanagawa (JP); Sachika Tashiro, Kanagawa (JP)

(73) Assignee: Ricoh Company, Ltd., Tokyo (JP)

(21) Appl. No.: 18/939,423

(22) Filed: Nov. 6, 2024

(30) Foreign Application Priority Data
Nov. 9, 2023 (JP) 2023-191497

(51) Int. Cl. A61J 7/00; A61J 7/04

(52) U.S. Cl. CPC A61J 7/0084; A61J 7/0069; A61J 7/0454; A61J 7/0463

(57) ABSTRACT

A medication support apparatus includes a container to store medicine packs, a medicine dispenser in which specific one of the medicine packs is disposed at a prescribed position, a picking-up conveyor to pick up one of the medicine packs from the container and convey one of the medicine packs to the prescribed position of the medicine dispenser, a pack data reader to read medication-related information added to at least one of the container or the medicine packs and medicine-dispensing data added to the medicine dispenser, and processing circuitry configured to manage the medication-related information, manage the medicine-dispensing data, search for a combination of the container from which one of the medicine packs is picked up and the medicine dispenser to which one of the medicine packs is dispensed, based on the medication-related information read by the pack data reader and the medicine-dispensing data read by the pack data reader.

### CROSS-REFERENCE TO RELATED APPLICATION

This patent application is based on and claims priority pursuant to 35 U.S.C. § 119(a) to Japanese Patent Application No. 2023-191497, filed on Nov. 9, 2023, in the Japan Patent Office, the entire disclosure of which is hereby incorporated by reference herein.

### BACKGROUND

### Technical Field

The present disclosure relates to a medication support apparatus.

### Background Art

Some technologies have been proposed to dispense medicine packages, each of which may be referred to simply as a pack or a medicine pack in the following description, to a medicine dispensing tray to which medicines to be taken by several persons in a day-care center or nursing home are dispensed. In such technologies, the data that is indicated on a pack or a container is read, and the read data is compared with the medication-related information stored in, for example, a personal computer (PC). Moreover, a pack is taken out from the container that stores medicine packs, and is conveyed to a specific position of the medicine dispensing tray or the like.

### SUMMARY

The present disclosure described herein provides a medication support apparatus including a container to store medicine packs, a medicine dispenser in which specific one of the medicine packs is disposed at a prescribed position, a picking-up conveyor to pick up the specific one of the medicine packs from the container and convey the specific one of the medicine packs to the prescribed position of the medicine dispenser, a pack data reader disposed on the picking-up conveyor, to read medication-related information added to at least one of the container or the medicine packs and medicine-dispensing data added to the medicine dispenser, the medication-related information including a name of a patient who takes medicines and a time of medication, the medicine-dispensing data including the name of the patient who takes the medicines and the time of the medication, and processing circuitry configured to manage the medication-related information, manage the medicine-dispensing data, search for a combination of the container from which the specific one of the medicine packs is picked up and the medicine dispenser to which the specific one of the medicine packs is dispensed, based on the medication-related information read by the pack data reader and the medicine-dispensing data read by the pack data reader, and automate a medicine dispensing operation based on the combination.

### BRIEF DESCRIPTION OF THE DRAWINGS

A more complete appreciation of embodiments and the many attendant advantages thereof will be readily obtained as the same becomes better understood by reference to the following detailed description when considered in connection with the accompanying drawings.

FIG. 1A is a schematic front view of a medicine dispensing apparatus that makes up a medication support device.

FIG. 1B is a side view of the medicine dispensing apparatus of FIG. 1A.

FIG. 2A is a plan view of a single medicine package.

FIG. 2B is a side view of the single medicine package of FIG. 2A viewed in a direction indicated by an arrow A.

FIG. 2C is a side view of bound medicine packages.

FIG. 2D is a diagram illustrating a typical form of continuous packs.

FIG. 3 is an external perspective view of a medicine dispensing tray.

FIG. 4A is a diagram illustrating the attachment of a label with a quick response code (QR CODE) to be placed in a subdivision box.

FIG. 4B is a diagram illustrating how a label with a QR CODE is displayed.

FIG. 5A is a vertical sectional view of a cartridge.

FIG. 5B is a bottom view of the cartridge of FIG. 5A.

FIG. 6A is another vertical sectional view of a cartridge different from that of FIG. 5A.

FIG. 6B is a bottom view of the cartridge of FIG. 6A.

FIG. 7 is a schematic plan sectional view of the attaching and detaching mechanisms for the cartridge, which are arranged on a drawer.

FIG. 8 is a schematic plan view of cartridges, illustrating the mechanisms for recognizing each one of the cartridges arranged in a drawer.

FIG. 9A is a front view of a carriage, illustrating a schematic configuration or structure of the carriage.

FIG. 9B is a plan view of the carriage of FIG. 9A.

FIG. 10 is a front view of a carriage, illustrating the progression of the operation of the carriage.

FIG. 11A to FIG. 11F are front views of a carriage, illustrating the progression of the operation of the carriage subsequent to the operation illustrated in FIG. 10.

FIG. 12A to FIG. 12C are front views of a carriage, illustrating the progression of the operation of the carriage subsequent to the operations illustrated in FIG. 11A to FIG. 11F.

FIG. 13 is a front view of a cartridge, illustrating the operation of scanning the medication-related information displayed on the cartridge.

FIG. 14A is a front view of a conveyor, illustrating a schematic configuration of the conveyor.

FIG. 14B is a side view of the conveyor of FIG. 14A.

FIG. 15 is a diagram illustrating the control blocks of a medicine dispensing apparatus.

FIG. 16 is a diagram illustrating the control blocks of a medication support device.

FIG. 17A, FIG. 17B, and FIG. 17C are schematic diagrams of a cartridge sensor that detects the attachment and detachment of a cartridge.

FIG. 18A-1 and FIG. 18B-1 are diagrams of a cartridge tray to which a cartridge is not yet attached.

FIG. 18A-2 and FIG. 18B-2 are diagrams of a cartridge tray to which a cartridge is attached.

FIG. 19 is a bottom view of multiple cartridge trays on each of which a cartridge sensor is mounted.

FIG. 20A is a diagram illustrating an operation to detect that a group of integrated cartridges is not yet attached to a cartridge-tray placement unit, using a cartridge sensor.

FIG. 20B is a diagram illustrating an operation to detect that a group of integrated cartridges is attached to a cartridge-tray placement unit, using a cartridge sensor.

FIG. 21 is a diagram illustrating a medicine dispensing apparatus in which the management of each cartridge tray is performed separately.

FIG. 22 is a diagram illustrating an operation screen of a management application.

FIG. 23 is a flowchart of the controlling processes as to whether scanning and reading are successfully performed.

FIG. 24 is a diagram illustrating a system configuration of a medicine dispensing apparatus.

FIG. 25 is a table depicting management data in a pack data management system.

FIG. 26 is a table depicting management data in a medicine-dispensing data management system.

FIG. 27 is a diagram illustrating how a search is carried out in a medicine-dispensing data searching system.

FIG. 28 is a diagram depicting combinations of medicine-dispensing data in a medicine-dispensing data searching system.

FIG. 29 is a flowchart of a medicine dispensing operation by a medicine dispensing controller FIG. 30 is a diagram illustrating a configuration or structure of a display management system.

FIG. 31A is a front view of a medicine dispensing apparatus, illustrating the arrangement of a monitor, a warning light, a group of LEDs to indicate the status of cartridge trays, and a group of LEDs to indicate the status of subdivision boxes, which are connected to the medicine dispensing apparatus.

FIG. 31B is a side view of the medicine dispensing apparatus of FIG. 31A.

FIG. 32A to FIG. 32E are diagrams each of which illustrates how the status of a device is displayed using a monitor.

FIG. 33A to FIG. 33F are diagrams each of which illustrates how the status of a device is displayed using a warning light.

FIG. 34 is a diagram illustrating the arrangement of a group of light-emitting diodes (LEDs) to indicate the status of subdivision boxes.

FIG. 35A is a front view of a medicine dispensing apparatus.

FIG. 35B is an enlarged view of a site where operation keys to gives instructions to dispense medicine to the medicine dispensing apparatus of FIG. 35A are arranged.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to limit the present disclosure. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing embodiments illustrated in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

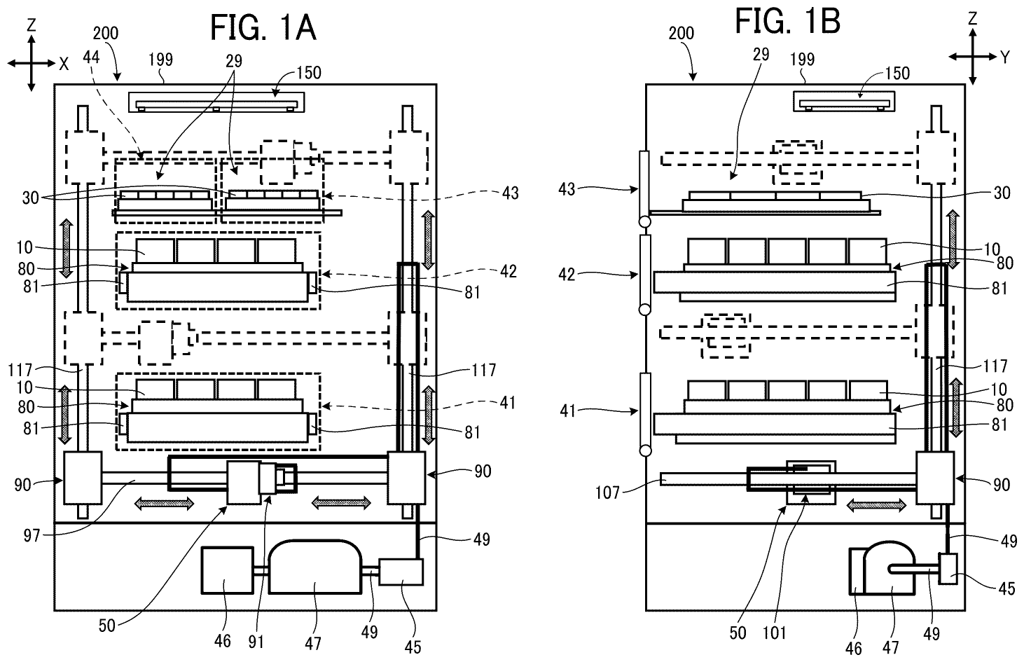

FIG. 1A is a schematic front view of a medicine dispensing apparatus 200.

FIG. 1B is a schematic side view of the medicine dispensing apparatus 200 of FIG. 1A.

As illustrated in FIG. 1A and FIG. 1B, the medicine dispensing apparatus 200 is provided with a cartridge 10 that is also referred to as a first holder, a cartridge tray 20 that is also referred to as a second holder, a drawer 80, a medicine dispensing tray 30, a carriage 50 that is also referred to as a pickup device, a conveyor 90, and a first gate 41 to a fourth gate 44.

In FIG. 1A and FIG. 1B, the lateral direction, the depth direction, and the vertical direction of the medicine dispensing apparatus 200 are referred to as the X-axis direction, the Y-axis direction, and the Z-axis direction, respectively. The same applies to the other drawings given below.

Each one of the multiple cartridges 10 serves as a first container in which, for example, multiple medicine packages 2 packing several kinds of medicines 3 or bound medicine packages 2A, as will be described later in detail, are stored upon being stacked on top of each other in layers. The medicine package 2 may be referred to simply as a pack or a medicine pack in the following description. The multiple cartridges 10 are arranged at a middle portion and a lower portion of the housing 199 of the medicine dispensing apparatus 200 through the cartridge tray 20. The multiple cartridges 10 are attachable to and detachable from the cartridge tray 20 that serves as a second container. The expression “stored upon being stacked on top of each other in layers” in the present disclosure indicates keeping the packs horizontally in such a manner that the front face is viewable.

As will be described later in detail, the cartridge tray 20 can store multiple cartridges 10 upon positioning those cartridges as desired. The cartridge tray 20 serves as a second container in which at least one of the multiple cartridges 10 is placed and held.

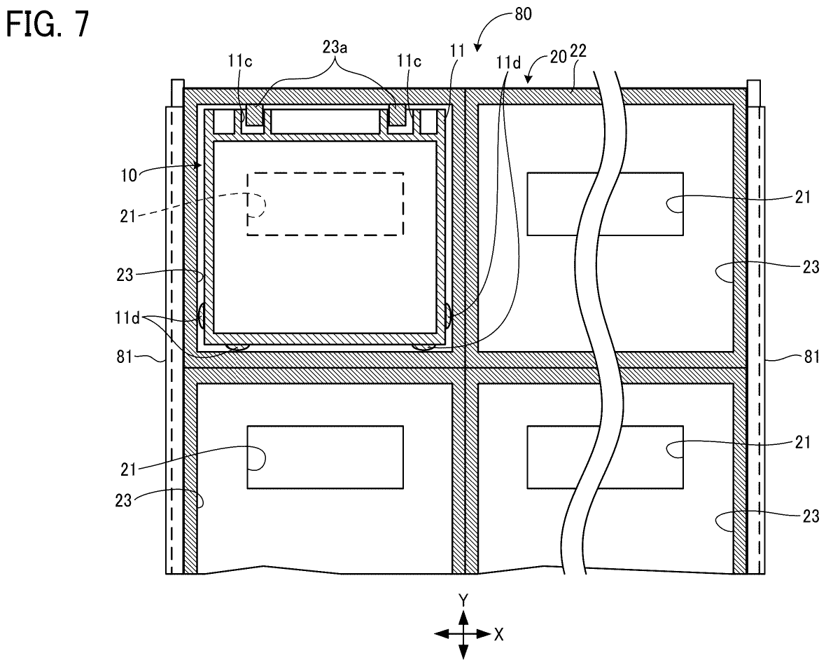

The cartridges 10 are placed in the pair of drawers 80 through the cartridge tray 20. One of the pair of drawers 80 is arranged at a lower area of the housing 199 of the medicine dispensing apparatus 200, and the other one of the pair of drawers 80 is arranged at a middle area of the housing 199 of the medicine dispensing apparatus 200. In the case of the medicine dispensing apparatus 200 as illustrated in FIG. 1A and FIG. 1, twenty cartridges 10 (4×5=20) are placed and held in one of the cartridge trays 20 of one of the pair of drawers 80, as will be described later in detail with reference to FIG. 7.

For the sake of explanatory convenience, each one of the multiple drawers 80 may be referred to as the cartridge tray 20 in the following description. Each of the multiple cartridges 10 is placed and housed in a partitioned lattice-like side wall and bottom wall in the cartridge tray 20. On the bottom wall of the cartridge tray 20 corresponding to the cartridges 10, a rectangular through opening 21 through which a pack can be picked up from below one of the multiple cartridges 10, making use of the elasticity or free deformation of the pack as will be described later in detail in relation to the operation, is formed as will be described later in detail with reference to FIG. 7.

The drawer 80 can align and hold the cartridge tray 20. In other words, a pair of slide rails 81 are attached to the outer side wall of the drawer 80, and a rail of the housing 199 is disposed on the housing 199 so as to be fitted to the slide rails 81 of the drawer 80. Due to such an engagement between the rail of the housing 199 and the slide rail 81, the drawer 80 in which one of the multiple cartridge trays 20 is stored and held can be pulled out from the housing 199.

Each one of the multiple medicine dispensing trays 30 is an example of a medicine dispenser or medicine dispensing table in which the prescribed packs conveyed by the conveyor 90 are arranged. As illustrated in FIG. 1A and FIG. 1B, a pair of medicine dispensing trays 30 are arranged above the multiple cartridges 10 mounted on the cartridge tray 20 in the uppermost one of the multiple drawers 80. The areas that include the medicine dispensing trays 30 where the packs are passed to the medicine dispensing tray 30 for automatic medicine dispensing are referred to as medicine dispensing areas 29 in the following description.

The carriage 50 is an example of a pickup device that picks up a specific pack from a cartridge. The conveyor 90 is an example of a conveyor that conveys the pack picked up from the cartridge 10 by the carriage 50. The pickup device such as the carriage 50 as well as the conveyor such as the conveyor 90 serve as a picking-up conveyor according to one aspect of the present disclosure that picks up specific one of the multiple medicine packs from the container such as one of the multiple cartridges 10 and conveys the picked-up medicine pack to a specific position of a medicine dispenser that serves as a medicine dispensing tray 30.

Each one of the first gate 41 and the second gate 42 serves as an entrance and exit gate for the container, which allows one of the multiple cartridges 10 and the cartridge tray 20 to enter and exit the housing 199 through the drawer 80. The multiple cartridges 10 are inserted and set in the housing 199 through each one of the first gate 41 and the second gate 42. The open and close door of one of the first gate 41 and the second gate 42 are opened, and the drawer 80 in which the cartridge trays 20 are aligned is drawn out to the front side. By so doing, the multiple cartridges 10 or the multiple cartridge trays 20 are inserted or withdrawn.

The third gate 43 and the fourth gate 44 according to the present comparative example of the embodiments of the present disclosure serve as a pair of entrance and exit gates for the medicine dispenser, which allow the multiple medicine dispensing trays 30 that are arranged in two rows at the uppermost stage of the medicine dispensing apparatus 200 to enter and exit the housing 199. The third gate 43 and the fourth gate 44 are arranged such that the packs can be taken out immediately after the packs are set or inserted into the medicine dispensing tray 30.

In the medicine dispensing apparatus 200, two medicine dispensing trays 30 are arranged as described above. As will be described later in detail, for example, medicine dispensing trays are arranged for each time of medication such as a timing in the morning, a timing during the daytime, a timing in the evening, and a timing before going to bed. The third gate 43 and the fourth gate 44 for the medicine dispensing tray 30 are also arranged for each one of the medicine dispensing trays 30. Due to such a configuration, another different one of the medicine dispensing trays 30 can be taken out even when the medicine dispersing operation is performed on a particular one of the multiple medicine dispensing trays 30.

The cartridge trays 20 as illustrated in FIG. 1A and FIG. 1B are collectively arranged in two stages on the upper and lower sides under the medicine dispensing trays 30 at the uppermost stage. However, no limitation is intended thereby, and the cartridge trays 20 may collectively be arranged on the upper side or the lower side. Depending on the number of persons in the day-care center or nursing home, the multiple cartridge trays 20 may be arranged in three stages.

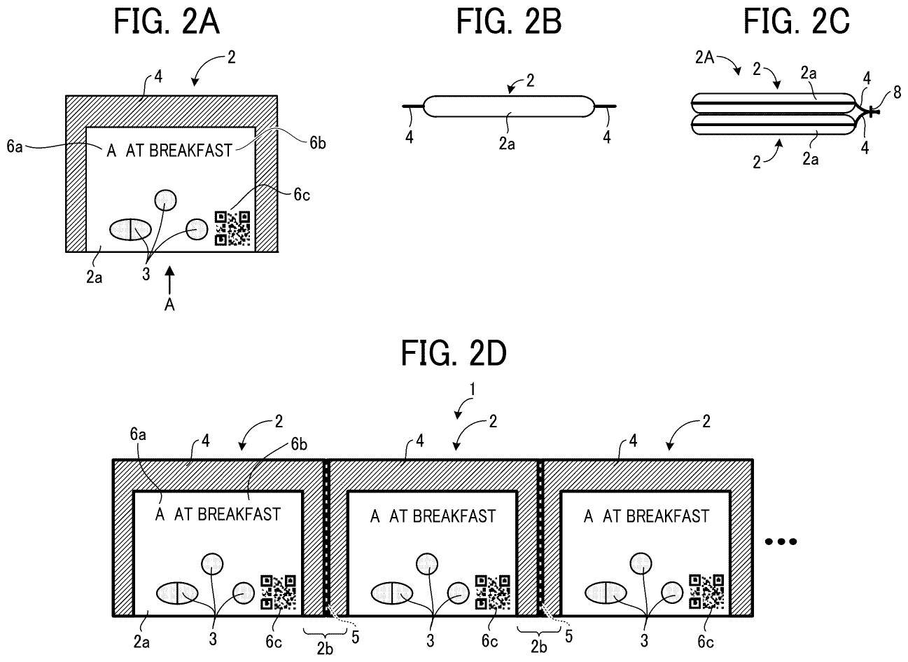

FIG. 2A is a typical plan view of a single medicine package 2.

FIG. 2B a side view of the single medicine package 2 of FIG. 2A viewed in a direction indicated by an arrow A.

FIG. 2C is a side view of the bound medicine packages 2A in which the medicine packages 2 are stacked on top of each other in layers.

FIG. 2D is a diagram illustrating a typical form of continuous packs 1.

Embodiments of the medicine package 2 include the single medicine package 2 and bound medicine packages 2A in which multiple medicine packages 2 are stacked on top of each other in layers and bound by a stapler or the like. The medicine package may be referred to simply as a pack or a medicine pack in the following description. In FIG. 2C, two medicine packages 2 are bound as the bound medicine packages 2A. In FIG. 2A to FIG. 2D and other diagrams, typically, the medicine package 2 is illustrated. However, as a matter of course, for example, the bound medicine packages 2A is also included even when only a single medicine package 2 is illustrated.

As illustrated in FIG. 2A, one medicine package 2 is formed of, for example, a resin film, and medicines 3 such as capsules or tablets are packed in small quantities. The medicine package 2 includes a bag 2a that covers the medicines 3 and a pressure-bonded portion 4 in which three sides of the bag 2a are pressure-bonded or welded. The pressure-bonded portion 4 is hatched in FIG. 2A and FIG. 2D. Typically, the side of the medicine package 2 on the bag 2a side is folded into two, and the medicines 3 are packed therebetween. The pressure-bonded portion 4 forms a leakage-preventing portion that prevents the medicines 3 from slipping out from the bag 2a. Typically, the medicines 3 in one medicine package 2 is a one-time dosage for a patient who takes medicines.

The medicine package 2 is dispensed and prepared by a drug-dispensing machine installed in, for example, a pharmacy. The dispensing sheets that serve as packages and are used for dispensing the medicines are rolled long-length sheets, and are perforated between packs. The dispensing sheets are rolled in an overlapping manner, and the medicines 3 to be taken are packed in the space between the sheets. The medicines 3 for a required number of doses are divided into small quantities and packed into the multiple medicine packages 2 that form a continuous sheet. The three sides other than the folded portion of each one of the multiple medicine packages 2 around the medicines 3 for a single dose are sealed in turn by the pressure-bonded portion 4. The multiple medicine packages 2 that form such a continuous sheet may be referred to as continuous packs 1 in the following description. In the continuous packs 1 that are described with reference to FIG. 2D, the multiple medicine packages 2 are coupled to each other and laid like a belt. In the present embodiment described with reference to FIG. 2D, the medicines 3 for three doses are illustrated. The continuous packs 1 are typical forms of drug or medicine that are given or sold at a pharmacy or the like to, for example, a user such as a person who actually takes the medicine 3 in the medicine package 2 and a personal care attendant or assistant who helps or assists the user to take medication, or a staff or the like including a pharmacist, a nurse practitioner, a care manager, or a medication assistant of, for example, various kinds of day-care center, nursing home, or medical institution. For the sake of explanatory convenience, each one of the packs is filled with the medicines 3 of the same form in the following description. In FIG. 2C, by way of example, each one of the packs is filled with the same capsule and the same tablets. However, no limitation is indicated thereby. As a matter of course, each one of the packs may be filled with different types of medicines depending on, for example, the usage or purposes of the medication.

In the present embodiment described with reference to FIG. 2A to FIG. 2D, the medicine package 2 has a rectangular shape in a plan view, and a packaging method in which three sides are crimped and sealed as in the present embodiment is called three-sided packaging in the related art. Most of the drug-dispensing machines available on the market prepare packs using the three-sided packaging method.

The pressure-bonded portion 4 has a band-like width of about 10 to 15 millimeters (mm), and has higher rigidity than the portion of the bag 2a that is a transparent or semitransparent film where the medicines 3 can be visually recognized therethrough. In the generation or dispensing by a drug-dispensing machine, a boundary portion 2b that is implemented by perforation 5 is formed in the center of the pressure-bonded portion 4 between a pair of the multiple medicine packages 2 making up the continuous packs 1. The multiple medicine packages 2 are adjacent to each other in an upstream-to-downstream direction. For example, a user who is not handicapped in the hand can obtain one medicine package 2 by tearing off at the perforation 5 by hand or by cutting near the perforation 5 with scissors or a dedicated cutter.

As illustrated in FIG. 2C, the bound medicine packages 2A may be used. The bound medicine packages 2A is formed by fastening multiple medicine packages 2 at the center of the three sides of the pressure-bonded portions 4 by stapling 8 (see FIG. 2C) or the like. In FIG. 2C, two medicine packages 2 are fastened together. For example, the bound medicine packages 2A may be formed by taping multiple packs together. Alternatively, the bound medicine packages 2A may be, for example, packs of Chinese herbal medicines or sheets of blister packs or press through packs (PTP) that are combined together.

As medication-related information such as the name of a patient who takes medicines and the times of medication, the first medication-related information is added to the surface of the bag 2a of the medicine package 2. Note also that the first medication-related information may be referred to simply as the medication-related information in the following description. As the medication-related information, medication-related information 6a in which the name of a patient who takes medicines such as the medicine 3 in the medicine package 2 is expressed in texts, medication-related information 6b in which the times of medication at which the medicine 3 is taken is expressed in texts, and medication-related information 6c in which the name of a patient who takes medicines and the times of medication are expressed by a quick response code (QR CODE) are added to the medicine package 2 as illustrated in FIG. 2A to FIG. 2D. The medication-related information 6a and 6b, which is textual information, and the medication-related information 6c, which is a quick response code (QR CODE), are added to the medicine package 2 as illustrated in FIG. 2A to FIG. 2D. However, no limitation is intended thereby, and for example, a radiofrequency identification (RFID) tag that is used when tag information is read using a bar code or short-range radio may be used.

Further, the medication-related information may be, for example, the type of the medicine or the shape of the medicine prescribed in a pack, the number of tablets, and the images or texts printed on the medicine itself. As the medication-related information, only individual information may be acquired and used, or items of information may be acquired and used in combination. For example, if confirmation of the patient who takes medicines is required, the information about the name of the patient who takes medicines is sufficient. If it is desired to prevent forgetting to take an important medicine, the information of the number of tablets of the medicine and the shape of the medicine in the pack is confirmed together with the information of the patient who takes medicines. In other words, the medication-related information includes at least one of the name of a patient who takes medicines, the times of medication at which the medicines in a pack are to be taken, and the number of tablets and types of the medicines prescribed in the pack.

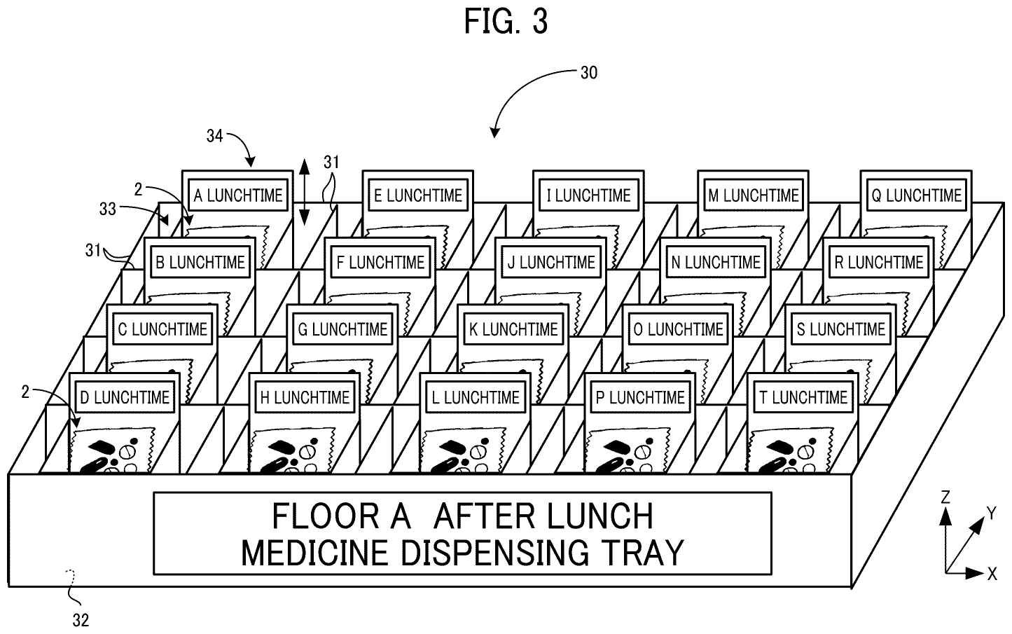

FIG. 3 is an external perspective view of the medicine dispensing tray 30.

As illustrated in FIG. 3, each one of the multiple medicine dispensing trays 30 has partition walls 31 that serve as dividers for arranging prescribed packs, and is partitioned by four upright partition walls 31. The twenty rooms 33 that are formed in each one of the multiple medicine dispensing trays 30 can be expressed as the components of a matrix including five columns in the X-axis direction or the line feed direction and four rows in the Y-axis direction or the character feed direction. As a result, each one of the twenty rooms 33 of the medicine dispensing trays 30 can be uniquely positioned based on the components and addresses of the matrix of five columns and four rows. Furthermore, each one of the multiple medicine dispensing trays 30 has a bottom wall 32 on which the multiple medicine packages 2 are placed. As described above, in the medicine dispensing tray 30, specific one of the multiple packs is placed in specific one of the multiple rooms 33 in a reliable manner by the multiple partition walls 31, which are four partition walls in the present embodiment, and a bottom wall 32 in common, so as not to be mixed up with packs in different one of the multiple rooms 33 or drop off from the bottom wall 32.

In the medicine dispensing tray 30 as illustrated in FIG. 3, “FLOOR A AFTER LUNCH MEDICINE DISPENSING TRAY” displayed on the front outer wall indicates that the tray is the medicine dispensing tray 30 in which the multiple packs to be taken after lunch by patients who take medicines and reside in the same floor A of, for example, a day-care center or nursing home are arranged. The same sets of medicines are to be taken after breakfast in the present embodiment, as indicated by the medication-related information 6a and 6b on the medicine package 2 as illustrated in FIG. 2A to FIG. 2D.

FIG. 3 illustrates one of the multiple medicine dispensing trays 30 where a subdivision box 34 attachable to and detachable from each one of the multiple rooms 33 is used. For example, the multiple subdivision boxes 34 hold the multiple medicine packages 2 filled with the medicines 3 to be taken by twenty residents A to T after lunch in a day-care center or nursing home. In other words, one of the multiple medicine dispensing trays 30 illustrated in FIG. 3 is used to arrange prescribed packs in a predetermined or specific one of the multiple rooms 33 partitioned by dividers through the multiple subdivision boxes 34. The operation of placing the multiple medicine packages 2 in one of the multiple medicine dispensing trays 30 is briefly described later with a case in which the multiple subdivision boxes 34 are not used.

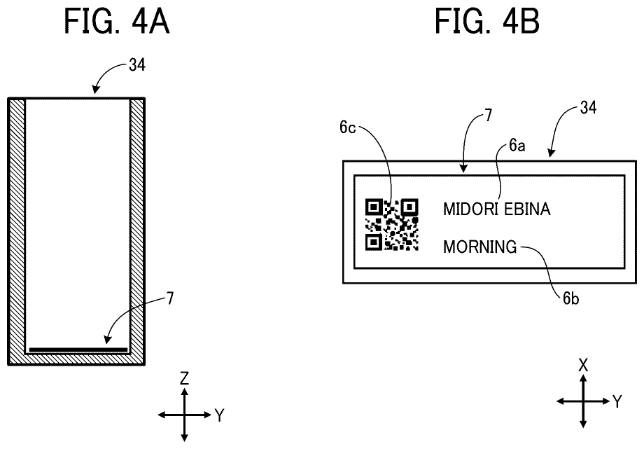

FIG. 4A is a diagram illustrating the attachment of the label 7 with a QR CODE to be placed in the subdivision box 34 used for the medicine dispensing tray 30.

FIG. 4B is a diagram illustrating how the label 7 with a QR CODE is displayed.

In order to specify the place to which one of the multiple medicine packages 2 picked up from one of the multiple cartridges 10 is to be dispensed, the medication-related information 6a that indicates the name of a patient who takes medicines, the medication-related information 6b that indicates the times of medication, or the label 7 with a QR code on which medication-related information 6c indicating the medication-related information 6a and the medication-related information 6b by a QR CODE is printed is pasted on the inner bottom face of one of the multiple subdivision boxes 34 of the medicine dispensing tray 30.

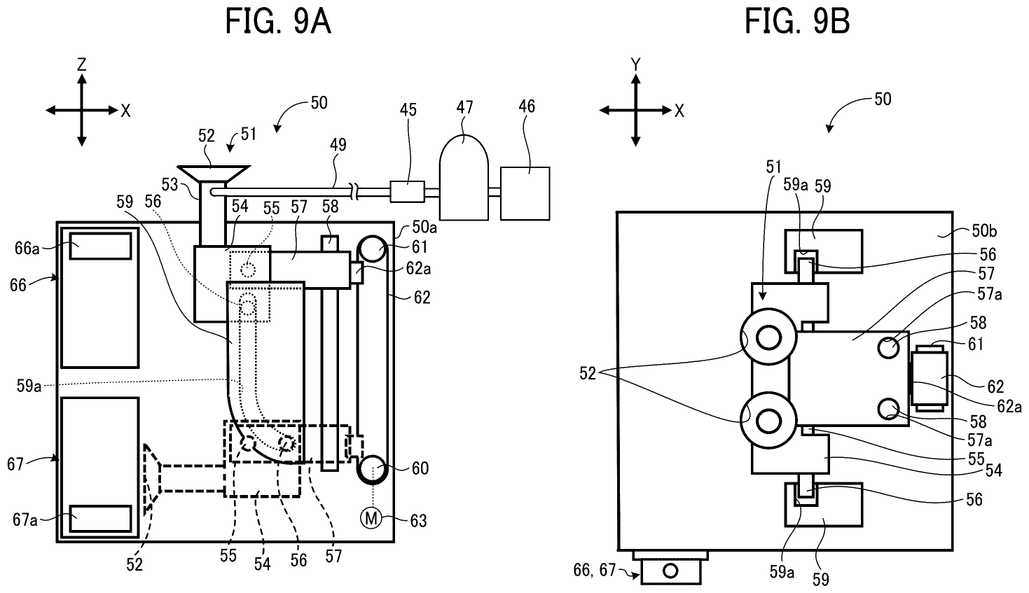

The QR CODE of the label 7 with a QR code is read by the lower QR code reader 67 as will be described later in detail with reference to, for example, FIG. 9A and FIG. 9B, the coordinates of the X position and the Y position, which are the information about the position of the carriage 50, are linked to a quick response code (QR CODE) that indicates the name of a patient who takes medicines and the times of medication. By so doing, the pack that is picked up from one of the multiple cartridges 10 can be dispensed to a desired position. The label 7 with a QR code may be directly attached to the subdivision box 34 in the form of a seal, or may be attached to a plate and arranged in the subdivision box 34. The label 7 with a QR code may be pasted to each one of the multiple rooms 33 of one of the multiple medicine dispensing trays 30, or a plate may be arranged when the subdivision box 34 is not to be used. With the use of the multiple subdivision boxes 34, the subdivision box 34 in which the multiple medicine packages 2 are stored can be picked up from the medicine dispensing tray 30, and a proper medicine package 2 can be moved under an occupant or patient who takes medicines. Accordingly, there is no worry about taking a wrong pack or dropping the pack.

In each one of the multiple rooms 33 of the multiple medicine dispensing trays 30, a setting position or inserting position is determined for each patient who takes medicines depending on the type of medicines in the pack to be taken. In other words, the multiple rooms 33 in one of the multiple medicine dispensing trays 30 may be allocated to patients who take medicines at the same time. In a case where a specific patient who is to take medicines does not take a medicine at a specific time of medication, the arrangement can be made such that a pack is not given to such a specific patient at the specific time of medication.

However, no limitation is intended by the medicine dispensing trays 30 described above. Each one of the multiple rooms 33 of one of the medicine dispensing trays 30 may be allocated for each time of medication of each patient who takes medicines. More specifically, in such an alternative embodiment of the present disclosure, the multiple rooms 33 may be allocated to each of the patients who take medicines in view of the time of medication of each one of the multiple medicine packages 2 to be taken in the morning, in the daytime, in the evening, or before going to bed. The medicine dispensing trays 30 of such cases may be managed on a room-by-room basis or a floor-by-floor basis in day-care centers or nursing homes where patients who take medicines reside, and the multiple medicine packages 2 for that day or a couple of days may be dispersed in advance to the multiple medicine dispensing trays 30.

According to the above alternative embodiment, allocating the rooms 33 based on each time of medication such as a time in the morning, a time in the daytime, a time in the evening, and a time before going to bed can prevent the time of medication from being mistaken by patients who take medicines. The configuration or structure of the multiple medicine dispensing trays 30 is not limited to the embodiments of the present disclosure described above, and various kinds of combinations are theoretically possible between patients who take medicines and the timing at which the medicines are to be taken. However, such combinations may go beyond the scope of the present disclosure, the description of such combinations is omitted.

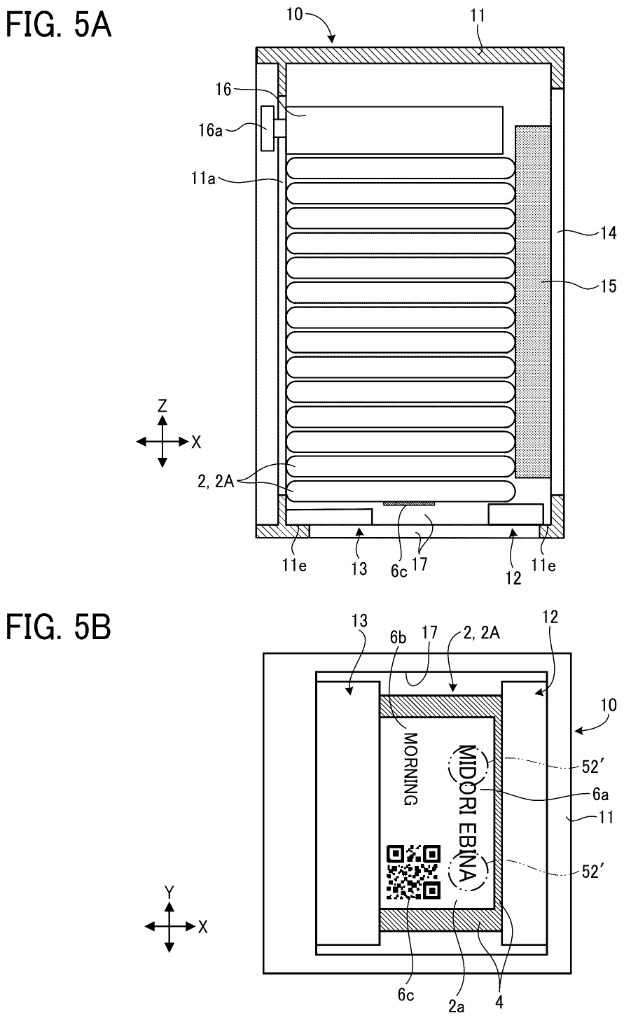

FIG. 5A is a vertical sectional view of the cartridge 10.

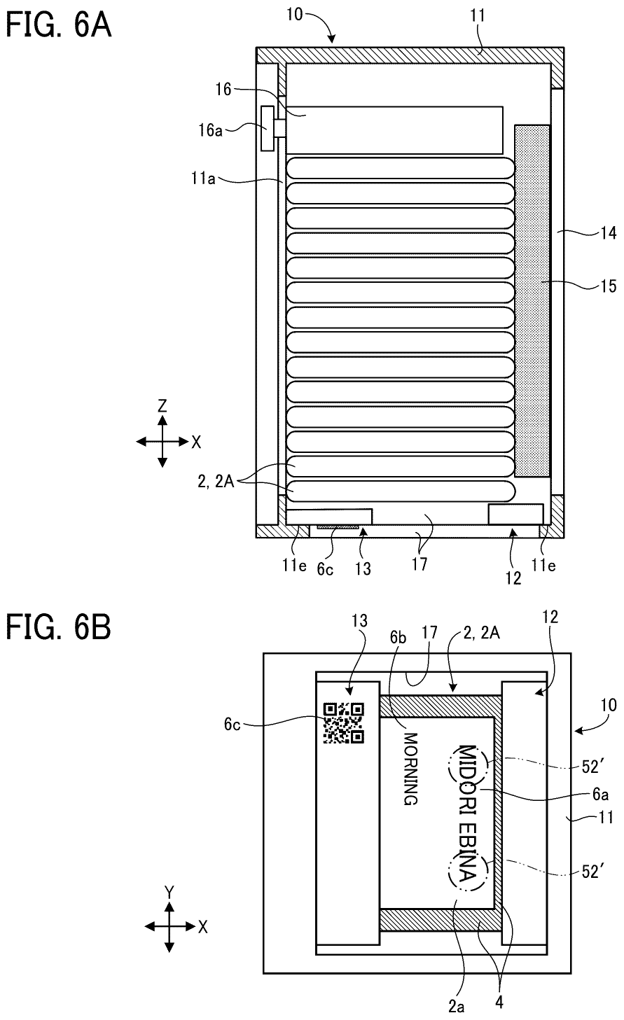

FIG. 6A is another vertical sectional view of the cartridge 10 different from that of FIG. 5A.

FIG. 5B is a bottom view of the cartridge of FIG. 5A.

FIG. 6B is a bottom view of the cartridge 10 of FIG. 6A.

One of the multiple cartridges 10 as illustrated in FIG. 5A and FIG. 5B is equivalent to one of the multiple cartridges 10 as illustrated in FIG. 6A and FIG. 6B in terms of, for example, the shape. One of the multiple cartridges 10 as illustrated in FIG. 5A and FIG. 5B is different from one of the multiple cartridges 10 as illustrated in FIG. 6A and FIG. 6B in terms of the position at which the QR CODE that indicates the medication-related information 6c is displayed and the member on which the QR CODE that indicates the medication-related information 6c is displayed. The configuration or structure in terms of, for example, the shape will be described with reference to FIG. 5A and FIG. 5B.

For example, each one of the multiple cartridges 10 includes a casing 11, a lid 14, a pack pickup slot 17, a movable board 16, a pack posture keeper 15, and a right support portion 12 and a left support portion 13 each of which is an example of a support portion. The casing 11 stores, for example, multiple medicine packages 2 or the bound packages 2A. In the following description, a single medicine package 2 will represent such multiple medicine packages 2 or bound packages 2A. For example, the casing 11 is integrally or separately formed using resin. The lid 14 enables the multiple medicine packages 2 to be loaded or unloaded. The pack pickup slot 17 is formed in a lower portion or a bottom portion of the casing 11, and is used to pick up the medicine package 2 in one of the multiple cartridges 10. Moreover, the pack pickup slot 17 allows the medicine package 2, which is picked up from one of the multiple cartridges 10 by the carriage 50 (see, for example, FIG. 1A, FIG. 1B, FIG. 9A, and FIG. 9B), to pass therethrough.

The movable board 16 prevents the medicine package 2 from falling out, and moves the lowermost one of the medicine packages 2 to a position close to the pack pickup slot 17 after the first one of the maximum number of medicine packages 2 that can be stored in the casing 11 is picked up. The pack posture keeper 15 keeps the posture of the medicine package 2. The right support portion 12 and the left support portion 13 also support or hold the medicine package 2 in the casing 11.

In the present embodiment, the to-be-picked-up portion of one of the multiple medicine packages 2 to be picked up from one of the multiple cartridges 10 by the carriage 50 is at a lower portion or bottom portion of the corresponding one of the multiple cartridges 10. In other words, the to-be-picked-up portion includes the pack pickup slot 17, and the right support portion 12 and the left support portion 13 that serve as a pair of support portions or supporting member and support, at multiple points, one of the multiple medicine packages 2 to be picked up from one of the multiple cartridges 10.

When one of the multiple medicine packages 2 is picked up from one of the multiple cartridges 10 by the carriage 50, the right support portion 12 and the left support portion 13 allow one of the multiple medicine packages 2 to pass through. On the other hand, when any one of the multiple medicine packages 2 is not to be picked up from one of the multiple cartridges 10, the right support portion 12 and the left support portion 13 restrict the passage of one of the multiple medicine packages 2 to store and hold the multiple medicine packages 2 in the casing 11.

As described above, the right support portion 12 and the left support portion 13 support or hold the medicine packages 2 in the cartridge 10, and each one of the right support portion 12 and the left support portion 13 is fixed and immovable such that one of the medicine packages 2 can be picked up in a stable manner from one of the multiple cartridges 10 by the carriage 50. The right support portion 12 and the left support portion 13 are a pair of fixation members that are fixed or attached to the pair of bottom-wall inner surfaces 11e of the right bottom-wall edge and left bottom-wall edge of the pack pickup slot 17, respectively. As will be described later in detail with reference to, for example, FIG. FIG. 9A and FIG. 9B, the pack pickup slot 17 has a function to allow the pair of suction pads 52 of the carriage 50 to pass therethrough in order to pick up one of the multiple medicine packages 2, and has a function to let the medicine package 2 that is picked up and the pair of suction pads 52 to pass through. In other words, the pack pickup slot 17 and the above right bottom-wall edge and left bottom-wall edge that are arranged so as to surround the pack pickup slot 17 together serve as a pack passing-through portion according to the present embodiment.

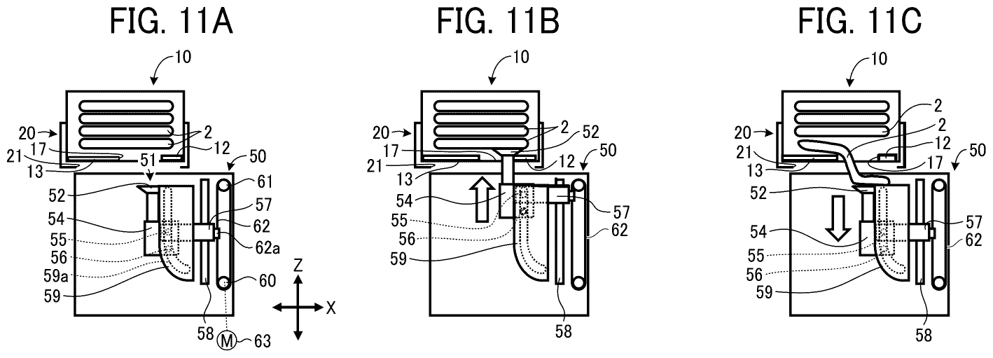

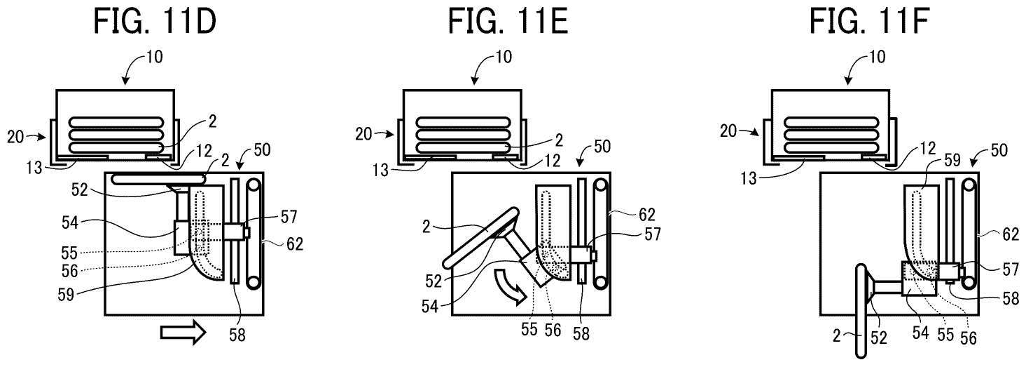

In one of the multiple cartridges 10 illustrated in FIG. 5A and FIG. 5B, a pair of positions 52′ at which the pair of suction pads 52 (as will be described later in detail with reference to FIG. 11C) adsorb or suck up one of the multiple medicine packages 2 stored in one of the multiple cartridges 10 are indicated by a pair of ring-shaped dot-dot-dash lines as illustrated in FIG. 5B. Such a pair of positions may be referred to as a pair of suction pad positions in the following description. The right support portion 12 and the left support portion 13 support the multiple medicine packages 2 in one of the multiple cartridges 10 such that the multiple medicine packages 2 in one of the multiple cartridges 10 do not fall off from the pack pickup slot 17. As will be described later in detail in regard to the operation of the carriage 50, when the medicine package 2 at the bottom of the cartridge 10 is sucked and picked up by the pair of suction pads 52, one of the multiple medicine packages 2 is sucked by the pair of suction pads 52 at a pair of suction-pad positions in the Y-axis direction near both ends of the right support portion 12. When the lowermost one of the medicine packages 2 is picked up from one of the multiple cartridges 10 by the pair of suction pads 52, the pair of suction pads 52 pass near both ends of the right support portion 12 in the Y-axis direction to suck and hold one of the medicine packages 2.

As illustrated in FIG. 5B, two points at which the pair of suction pads 52 contact the medicine package are arranged near both ends of the right support portion 12 in the Y-axis direction. Due to such a configuration, the possibility of an error in which the suction by the pair of suction pads 52 is disabled can be avoided and prevented, and the picking up operation can successfully be done. In other words, the medicine package 2 is sucked and adhered to the pair of suction pads 52 at both ends in the Y-axis direction, and the bag 2a of the medicine package 2, which is made of film, is stretched by the suctioning of the pair of suction pads and withstands the deformation. Accordingly, both reliable support or holding of the multiple medicine packages 2 in one of the multiple cartridges 10 and smooth removal of one of the multiple medicine packages 2 can be achieved.

The pack posture keeper 15 is formed of sponge rubber having appropriate elasticity. The movable board 16 is made of, for example, resin or metal. The pack posture keeper 15 and the movable board 16 hold the posture of the multiple medicine packages 2 under normal operating conditions in the casing 11. As explicitly illustrated in FIG. 5A, the posture of the multiple medicine packages 2 is held orderly in the Z-axis direction in a substantially horizontal state. In order to achieve the above-described function, the movable board 16 is arranged to move at least one of the multiple medicine packages 2 left in the casing 11 toward the pack pickup slot 17 as moving downward in the casing 11 in the Z-axis direction by its own weight. As illustrated in FIG. 5A, a long groove 11a that extends in the Z-axis direction with predetermined width in the X-axis direction is formed in the side wall of the casing 11. A shaft 16a with a flange is arranged at one end of the movable board 16 so as to protrude from the long groove 11a. As the shaft 16a of the movable board 16 is guided in the Z-axis direction parallel to the long groove 11a, the posture of the multiple medicine packages 2 can be held in the Z-axis direction. In FIG. 5A, the multiple medicine packages 2 in the multiple cartridges 10 are stacked on top of each other in layers in a substantially horizontal state. However, in actuality, left portions of the medicine packages 2 in FIG. 5A filled with the medicines 3 are expanding.

A set of the multiple medicine packages 2 are orderly stored in the casing 11 toward the upper side from the pack pickup slot 17 on the right support portion 12 and the left support portion 13. The timing at which the multiple medicine packages 2 are supplied into one of the multiple cartridges 10 may be, for example, the timing at which a patient who takes medicines or occupant is examined in a day-care center or nursing home, which is typically once a two weeks, or the timing at which the multiple medicine packages 2 in one of the multiple cartridges 10 run out. When some medicine packages 2 are left in one of the multiple cartridges 10 at the time of replenishment, such replenishment is continued from the back of the remaining medicine packages 2. Under normal operating conditions, the above-described setting of the multiple medicine packages 2 into one of the multiple cartridges 10 and the replenishment of the multiple medicine packages 2 are done by a staff or the like in a day-care center or nursing home. However, no limitation is indicated thereby. In particular, in configurations where cartridges are used instead of containers and setting or replenishment of the medicine packages 2 are done automatically, the setting or replenishment of the medicine packages 2 may be done differently.

The lid 14 is used by a staff or the like who works at a day-care center or nursing home to enable loading or unloading of the multiple medicine packages 2 stored in one of the multiple cartridges 10, and as illustrated in FIG. 5A, is formed with wide length in the Z-axis direction of the casing 11 and has a predetermined opening width.

As illustrated in FIG. 5B, the types of the multiple medicine packages 2 in one of the multiple cartridges 10 are sorted or divided based on the timings at which medicines are taken. For example, one cartridge contains medicines to be taken in fourteen days in the morning by, for example, Midori Ebina (Ms. A). In view of the above circumstances, if Ms. Midori Ebina (A) takes the medicines not only in the morning but also in the daytime or in the evening, or before going to bed, four cartridges 10 are required in total. However, no limitation is indicated thereby. For example, in an alternative embodiment of the present disclosure, a single cartridge 10 may be prepared for each person or patient who takes medicines. In such cases, for example, a pack to be used in the morning on day one, a pack to be used at lunchtime on day one, a pack to be used in the evening on day one, a pack to be used before going to bed on day one, a pack to be used in the morning on day two, a pack to be used at lunchtime on day two, and a pack to be used in the evening on day two may be stored in the order listed upward from the pack pickup slot 17 parallel to the direction in which packs are taken out from the multiple cartridges 10.

A left flap portion of a lap mechanism provided with a helical torsion coil spring having pressing force within a predetermined range between the rotation axis and the right bottom-wall edge may be used in combination with a right flap portion that is openable and closable and can swing about a rotation axis arranged around the right bottom-wall edge of the pack pickup slot 17. However, in such a comparative example, the pack tends to be caught and clamped between the left flap portion or the right flap portion and the bottom-wall inner surface 11e of the pack pickup slot 17 when the pack is picked up from one of the cartridge 10 that is an example of a container, and the operation of picking up the medicine package 2 is unstable.

In the embodiment described above, the right support portion 12 and the left support portion 13 are fixed to the bottom-wall inner surface 11e of the pack pickup slot 17 of the casing 11 such that one of the multiple medicine packages 2 can be picked up in a stable manner from one of the multiple cartridges 10 by the carriage 50. In other words, the right support portion 12 and the left support portion 13 are fixed when the right support portion 12 and the left support portion 13 hold both ends of the medicine pack such as the medicine package 2 or the bound medicine packages 2A around the pack pickup slot 17 arranged at the lower portion of one of the multiple cartridges 10.

The medicine package 2 that is stored in the cartridge 10 is supported by a right support portion 12 and a left support portion 13 so as not to drop. The right support portion 12 supports a right end where the medicine package 2 is sucked up, and the left support portion 13 supports a left end on the other side. The right support portion 12 and the left support portion 13 are different in the length of the portion that support the multiple medicine packages 2, and the length of portion of the right support portion 12 that support the multiple medicine packages 2 is shorter than that of the left support portion 13. When the lowermost one of the multiple medicine packages 2 stored in one of the multiple cartridges 10 is adsorbed or sucked by the suction pad 52 and is from the cartridge 10, the medicine pack such as the medicine packages 2 is bent or freely deformed due to its elasticity. Accordingly, the medicine pack can easily be pulled out. Such a configuration and operation is described later in detail with reference to FIG. 11C.

In such a configuration, the pair of support portions including the right support portion 12 and the left support portion 13 are of fixed type. Accordingly, the front end of the next one of the multiple medicine packages 2 to be taken out can be reliably held and does not jump out or fall off together with one of the multiple medicine packages 2 that is being taken out. As the pair of support portions including the right support portion 12 and the left support portion 13 do not swing or rotate, the medicine package 2 are held with high stability with no deformation or the like due to unintentional nipping or pressing in the returning operation.

As illustrated in FIG. 5A and FIG. 5B, the medication-related information 6a, 6b, and 6c that are displayed on a medicine pack such as the medicine package 2 or the bound medicine packages 2A are exposed from the pack pickup slot 17 of the cartridge 10. The medication-related information 6c of the medicine pack can be read by the upper QR code reader 66 mounted on the carriage 50, as will be described later in detail with reference to FIG. 9A and FIG. 9B. For the sake of explanatory convenience, in FIG. 5A and FIG. 5B, the medication-related information 6c is displayed only on, for example, the medicine package 2 or the bound medicine packages 2A that is stored at the bottom of one of the multiple cartridges 10, but the medication-related information 6c is displayed on, for example, all the medicine packages 2 or the bound medicine packages 2A that are stored in one of the multiple cartridges 10.

For example, when a drug-dispensing machine that makes, for example, the medicine package 2 cannot print a QR CODE and the medication-related information 6c such as a QR CODE cannot be applied to a medicine pack such as the medicine package 2 or the bound medicine packages 2A, the QR code may be arranged as illustrated in FIG. 6A and FIG. 6B. In other words, as illustrated in FIG. 6A and FIG. 6B, the label 7 with QR CODE that indicates the medication-related information 6c is pasted to the bottom face of the left support portion 13 close to the pack pickup slot 17. As a result, the medication-related information 6c of the medicine pack such as the bound medicine packages 2 or the bound medicine packages 2A that is stored in one of the multiple cartridges 10 can be obtained. In order to obtain the medication-related information 6c, the QR CODE may directly be printed on the cartridge 10 instead of pasting a label of the QR CODE.

FIG. 7 is a schematic plan sectional view of the attaching and detaching mechanisms for the cartridge 10, which are arranged on the drawer 80.

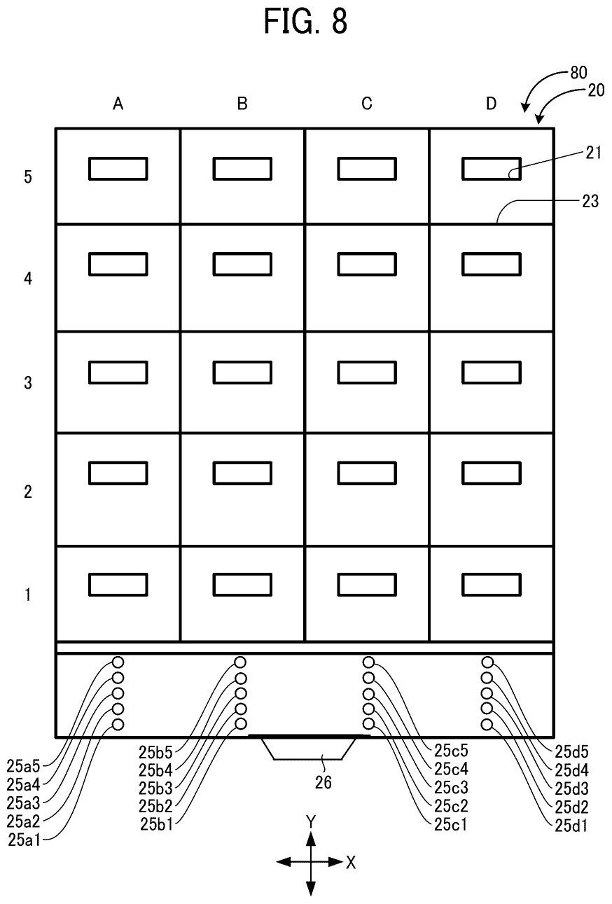

FIG. 8 is a schematic plan view of the cartridges 10, illustrating the mechanisms for recognizing each one of the cartridges, which are arranged in the drawer 80.

As illustrated in FIG. 7, the drawer 80 is configured to allow the multiple cartridges 10 to be attachable and detachable through the cartridge tray 20. In the related art, such a detachable cartridge 10 may be referred to as a container. The drawer 80 is integrally formed with the cartridge tray 20 to hold the cartridge tray 20. The casing 22 of the cartridge tray 20 in the drawer 80 is provided with a pair of slide rails 81 on the right and left outer side walls, respectively, and the pair of slide rails 81 are slidable with a pair of rails provided for the housing 199 (see FIG. 1A and FIG. 1). Due to such a configuration, the multiple cartridge trays 20 in the drawer 80 can be attached or detached by being pulled out from the housing 199 (see FIG. 1A and FIG. 1B) through the engagement between the slide rail 81 and the one of the multiple rails of the housing 199.

As illustrated in FIG. 7, one of the multiple cartridges 10 is attached to and detached from the cartridge tray 20 in the drawer 80 through the engagement and disengagement between a pair of concave portions 11c on the external wall of the casing 11 of the cartridge 10 and a pair of convex portions 23a that are formed on the inner wall of the casing 22 of the drawer 80 and protrude inwardly and the engagement and disengagement between the inner wall of the casing 22 and four hemispherical protrusions 11d on the external wall of the casing 11. With the above-described attaching and detaching mechanism of the drawer 80, the multiple cartridges 10 can be attached or detached easily and with good operability.

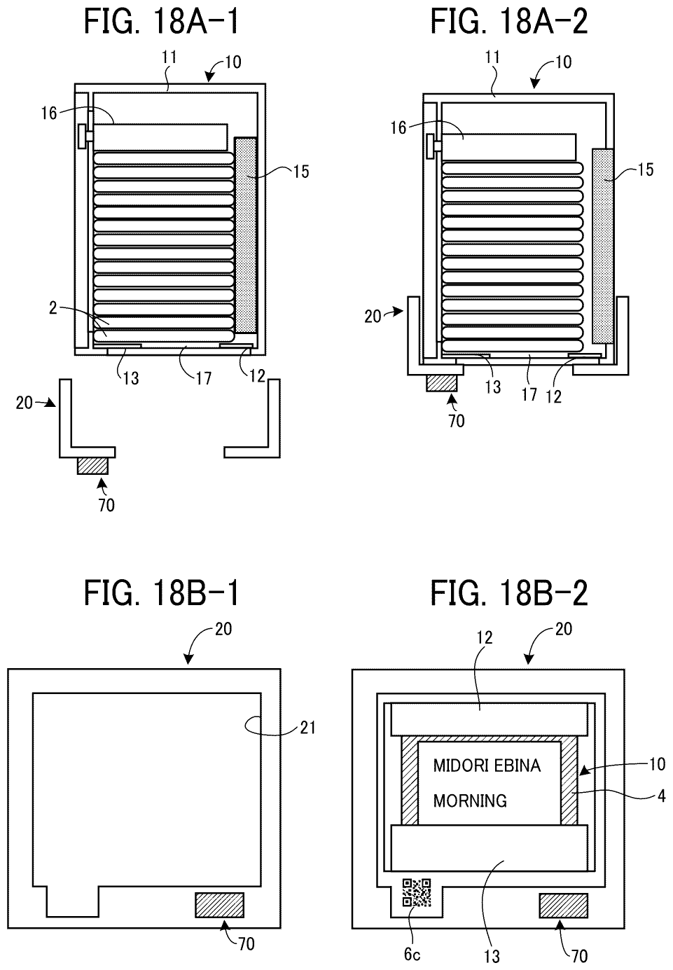

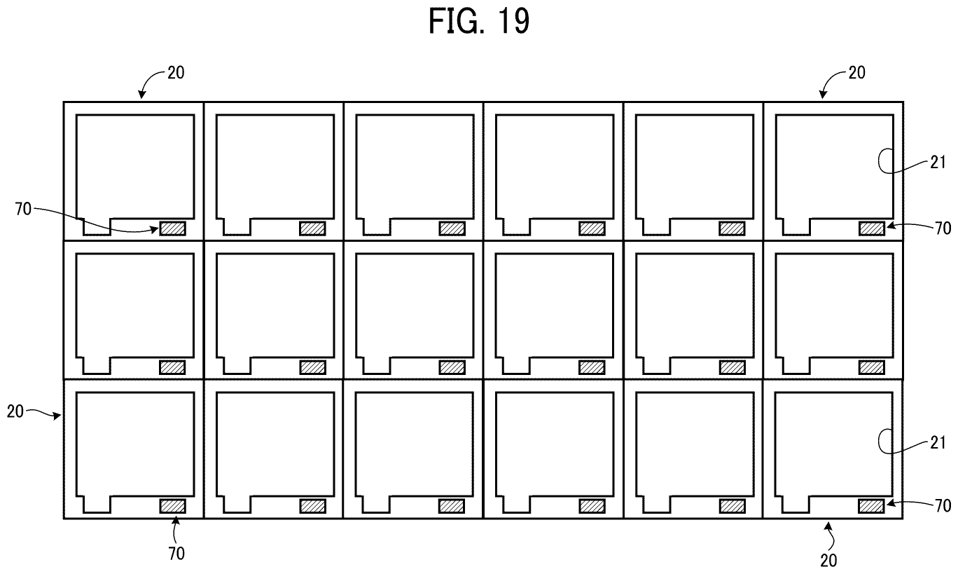

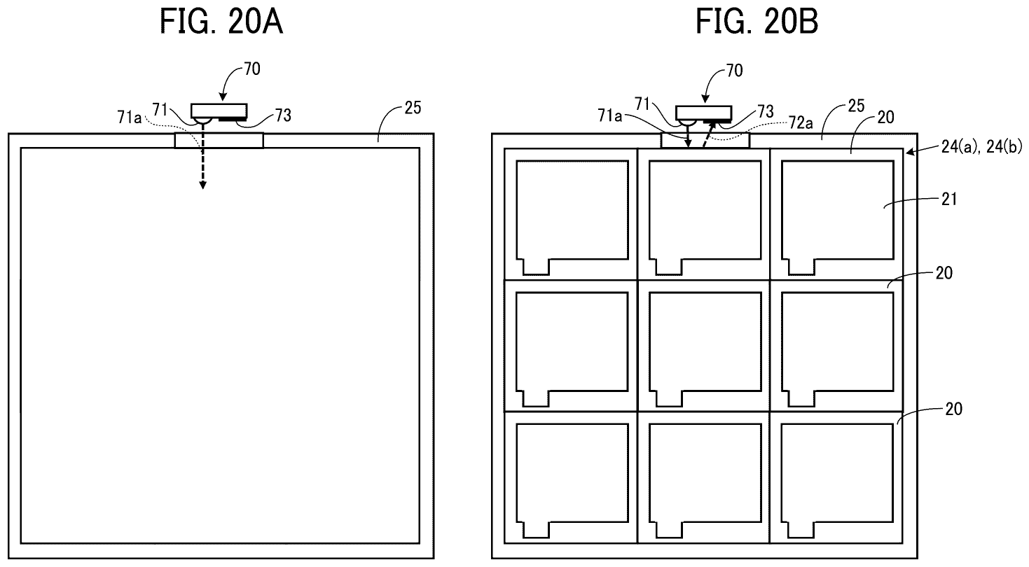

In the above embodiments of the present disclosure, attachment and detachment are enabled by the coupling or engagement of concave and convex portions. However, no limitation is intended thereby, and an elastic member may be arranged in the gap between the inner wall of the casing 22 and the external wall of the casing 11 to enable attachment and detachment. Alternatively, a configuration or structure using magnetic force or a snap-fit assembly method may enable attachment and detachment. As illustrated in FIG. 7 and FIG. 8, a rectangular through opening 21 that communicates with the pack pickup slot 17 of one of the multiple cartridges 10 as illustrated in FIG. 5A, FIG. 5B, FIG. 6A, and FIG. 6B when each one of the multiple cartridges 10 is attached to each container 23 of the cartridge tray 20 is formed on the bottom wall of the cartridge tray 20 of the drawer 80. The rectangular through opening 21 of the cartridge tray 20 as schematically illustrated in a relatively small size in FIG. 7 or FIG. 8, but as will be described later in detail with reference to, for example, FIG. 18A-1, FIG. 18A-2, FIG. 18B-1, FIG. 18B-2, FIG. 19, FIG. 20A, and FIG. 20B, may have a different shape.

As illustrated in FIG. 8, the cartridge tray 20 of the drawer 80 has containers 23 in which twenty cartridges 10 are stored. Each storage unit has four columns of A to D in the horizontal direction, and has five rows of 1 to 5 in the vertical direction. The drawer 80 has a grip 26 that is held by hand to insert or withdraw the drawer 80, and information display devices such as light-emitting diodes (LEDs) 25a1 to 25d5 are arranged near the grip. Due to such a configuration, the arrangement of the multiple cartridges 10 can easily be figured out. More specifically, due to such a configuration, at what position one of the multiple cartridges 10 in focus is placed in the cartridge tray 20 of the drawer 80 can easily be figured out at a glance. In FIG. 8, the light-emitting diode (LED) 25a1 is used to detect the presence or absence of one of the multiple cartridges 10 attached to or detached from a storage unit A1 of the cartridge tray 20. The storage unit A1 indicates a position or partition that is uniquely determined in the vertical columns and horizontal rows. In a similar manner to the above, the LED 25a2 corresponds to a portion of the storage unit A2 of the cartridge tray 20, and the LED 25a3 corresponds to a portion of the storage unit A3 of the cartridge tray 20. Moreover, the LED 25a4 corresponds to a portion of the storage unit A4 of the cartridge tray 20, and the LED 25a5 corresponds to a portion of the storage unit A5 of the cartridge tray 20. In a similar manner to the above, as illustrated in FIG. 8, each one of three columns of B to D and five rows of 1 to 5 of the multiple containers 23 is provided with an LED that indicates whether one of the multiple cartridges 10, which is attached to and detached from one of the multiple containers 23, is present.

When multiple information display devices such as the multiple LEDs 25a1 to 25d5 are used, for example, a staff who is an operator to attach one of the multiple cartridges 10 to one of the multiple containers 23 may mistake the lighting portion of the LEDs 25a1 to 25d5. In such cases, the cartridge 10 may erroneously attached to a wrong container other than a desired one of the containers 23. In order to handle such a situation, for example, whether the cartridge 10 is present may electrically or automatically be recognized by arranging detection units such as sensors or switches at the containers 23 in place of information display devices such as the multiple LEDs 25a1 to 25d5.

The container may be provided with for example, a number, a bar code, a quick response code (QR CODE), or a non-contact integrated circuit (IC) tag such that each one of the containers will be identifiable. It is desired that the system be programmed to remember what container stores whose medicines. Subsequently, the drawer 80 to which the multiple containers are attached is set in the housing 199 of the medicine dispensing apparatus 200, and each one of the multiple containers is identified by the medicine dispensing apparatus 200. Due to such a configuration, a desired pack can be picked up by the medicine dispensing apparatus 200 without causing any errors.

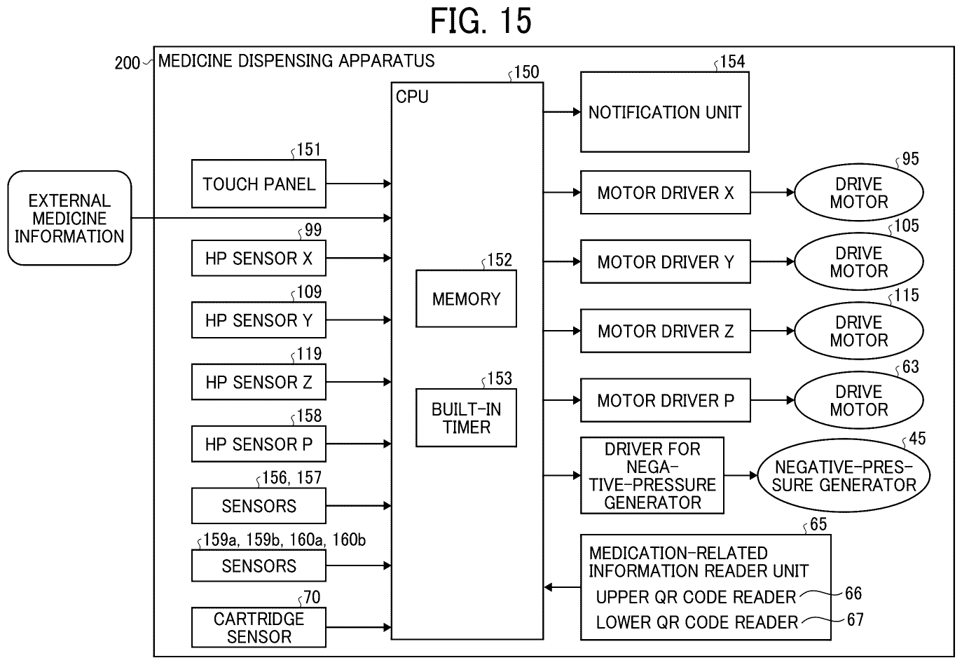

As will be described later in detail, the cartridge tray 20 that is arranged on the drawer 80 as illustrated in FIG. 7 or FIG. 8 may detect the attachment and detachment of the cartridge 10 using a sensor. Such a configuration or structure will be described later in detail with reference to, for example, FIG. 15.

FIG. 9A is a front view of the carriage 50, illustrating a schematic configuration or structure of the carriage 50.

FIG. 9B is a plan view of the carriage 50 of FIG. 9A.

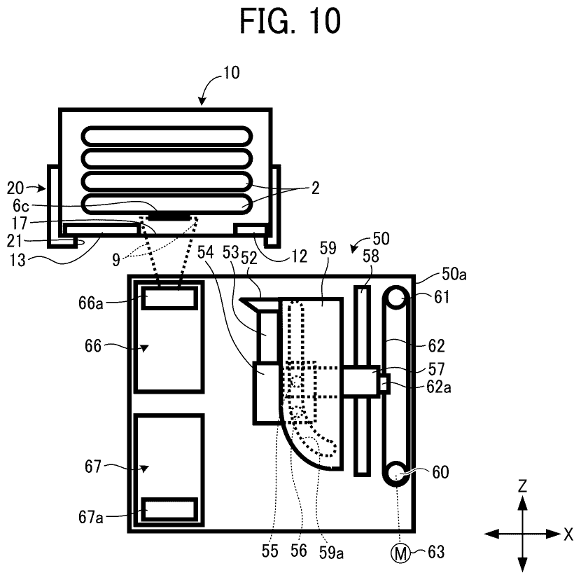

FIG. 10 to FIG. 12C are front views of the carriage 50, illustrating the progression of the operation of the carriage 50.

How elements such as a negative-pressure generator 45 are connected to the carriage 50 is illustrated in FIG. 9A.

As illustrated in FIG. 9A and FIG. 9B, the carriage 50 includes a suction device 51 to pick up and holds one of the medicine packages 2 from one of the cartridges 10. The suction device 51 has a function to such up and separate the medicine package 2. When the medicine package 2 is to be sucked up, the suction device 51 has a function to suck up the medicine package 2 using the air under negative pressure generated by the negative-pressure generator 45 that serves as a switching unit between positive pressure and negative pressure. The suction device 51 has a function to separate the medicine package 2 using the pressurized air generated by the negative-pressure generator 45 when the medicine package 2 is to be separated.

As illustrated in FIG. 9A, the suction device 51 as described above sucks up one of the multiple medicine packages 2 as the negative-pressure generator 45 transforms the positive pressure generated by an air compressor 46 that serves as an air compressing means into negative pressure through an air tank 47. The air compressor 46 is installed outside the conveyor 90, and is coupled to the suction device 51 through the air tank 47 and the negative-pressure generator 45 by a member for communication such as an air duct 49. In the air duct 49 between the negative-pressure generator 45 and the suction device 51, a pressure sensor that measures the negative pressure is arranged to determine that the suction device 51 has sucked up one of the multiple medicine packages 2 when the negative pressure measured by a pressure sensor that measures the negative pressure becomes equal to or less than a predetermined value.

The air duct 49 is arranged together with, for example, a CABLEVEYOR and a wire harness so as not to be stretched even when the carriage 50 moves inside the medicine dispensing apparatus 200. In other words, as illustrated in FIG. 1A and FIG. 1i, the air duct 49 has a one-turn path for each one of the X-axis, the Y-axis, and the Z-axis. Firstly, the air duct 49 is extended from the negative-pressure generator 45 in the Z-axis direction, and makes one turn. Secondly, the air duct 49 is extended in the X-axis direction, and makes one turn. Finally, the air duct 49 is extended in the Y-axis direction and makes one turn, and is coupled to the suction device 51.

The suction device 51 includes a pair of suction pads 52 that suck one of the multiple medicine packages 2, and a suction duct 53 coupled to the pair of suction pads 52. The negative-pressure generator 45 is also called a vacuum ejector valve and communicates with the suction duct 53 through the air duct 49. The pair of suction pads 52 is an example of an air suction unit or a suction member that sucks up and picks up one of the multiple medicine packages 2 in one of the multiple cartridges 10. As described above, the upper ends of the pair of suction pads 52 as illustrated in FIG. 9A is arranged to absorb one of the multiple medicine packages 2. The bottom ends of the pair of suction pads 52 as illustrated in FIG. 9A is attached and fixed to the upper end of the suction duct 53 as illustrated in FIG. 9A. The bottom end of the suction duct 53 as illustrated in FIG. 9A is attached and fixed to the suction-pad supporting member 54. The pair of suction pads 52 and suction ducts 53 are arranged in the Y-axis direction.

The carriage 50 is provided with a posture changing unit used to change the posture of one of the multiple medicine packages 2 picked up from one of the multiple cartridges 10 to a substantially vertical posture. The posture changing unit in the carriage 50 includes, for example, a suction-pad supporting member 54 coupled to a suction device base 57 through a rotary shaft 55, a guide unit 59 formed with a guide groove 59a having a specific shape, a guide axis 56 that is fitted into the guide groove 59a of the guide unit 59 to guide the suction-pad supporting member 54, and a suction-device lifting and lowering unit.

The suction-pad supporting member 54 is coupled to the suction device base 57 through the rotary shaft 55. The suction-pad supporting member 54 may be may rotatably or pivotably be arranged around the rotary shaft 55 fixed to the suction-pad supporting member 54 within a range of a predetermined angle. Alternatively, the suction-pad supporting member 54 may be may rotatably or pivotably be arranged around the rotary shaft 55 fixed to the suction device base 57. In other words, in FIG. 9A and FIG. 9B, the distance between the center of the rotary shaft 55 and the center of a guide rod 58 in the X-axis direction, as will be described later in detail, is kept constant when the suction device base 57 moves along the guide rod 58 in up and down directions Z.

The suction-device lifting and lowering unit includes a pair of guide rods 58 that are arranged in the Y-axis direction to guide the suction device base 57 in the Z-axis direction, an endless belt 62 looped around a driving pulley 60 and a driven pulley 61, and a drive motor 63 coupled to the driving pulley 60 through a driving power conveyor such as a gear or a belt. The drive motor 63 is an example of a driver circuit or driving source of the suction-device lifting and lowering unit.

The suction device base 57 is coupled and fixed to the endless belt 62 at a belt grip 62a fixed to the right end of the suction device base 57. A pair of guide rods 58 that extend in the Z-axis direction are arranged in the Y-axis direction, and the bottom ends of those guide rods 58 are fixed to a base frame 50b of a picking-up frame 50a provided for the carriage 50.

A pair of guiding holes 57a into which the pair of guide rods 58 are inserted are formed around a right end of the suction device base 57. The pulley axis of each one of the driving pulley 60 and the driven pulley 61 is rotatably supported by an immovable member on the picking-up frame 50a. The drive motor 63 is fixed to an immovable member provided for the picking-up frame 50a of the carriage 50.

When the suction device base 57 is lifted or lowered by the operation of the drive motor 63, the suction device base 57 is moved along the pair of guide rods 58 in the Z-axis direction. Accordingly, the posture of the suction device base 57 on the XY plane can be kept constant in a substantially horizontal state. The suction unit lifting and lowering unit is not limited to the above-described up-and-down reciprocating mechanism driven by a belt. Alternatively, for example, the suction unit lifting and lowering unit may have a reciprocating linear motion mechanism using a rack and pinion.

A pair of guide units 59 are arranged on both sides of the suction device 51 in the Y-axis direction across the suction-pad supporting member 54, and the bottom end of the guide unit 59 is fixed to the base frame 50b. The guide axis 56 is arranged at both ends of the suction-pad supporting member 54 in the Y-axis direction so as to protrude, and is consistently fitted into the guide groove 59a of the guide unit 59 to guide the suction-pad supporting member 54, and a suction pad lifting and lowering unit. As illustrated in FIG. 9A, the guide axis 56 is arranged under the rotary shaft 55 of the suction-pad supporting member 54 in the Z-axis direction, at a certain distance from the rotary shaft 55.

When the suction device base 57 is moved in the Z-axis direction by the operation of the drive motor 63, the guide axis 56 of the suction-pad supporting member 54 is moved in the Z-axis direction parallel to the guide groove 59a having a specific shape while maintaining the posture of the suction device base 57 on the XY plane constant in a substantially horizontal state. Due to such a configuration, the posture of the pair of suction pads 52 can be rotated by approximately 90 degrees. In FIG. 9A, the suction device 51 that is rotated by approximately 90 degrees is indicated by thick broken lines. In the present embodiment, the expression “substantially horizontal state” indicates that the posture of a particular element is within a specific range of tolerance for angle with respect to the horizontal in addition to a state in which the position of a particular element is horizontal.

The guide groove 59a having a specific shape includes the first guide groove portion that extends in the Z-axis direction with relatively great length so as to hold the posture of the pair of suction pads 52 upward as indicated by solid lines in FIG. 9A through the suction-pad supporting member 54 in a substantially horizontal state as guided by the guide axis 56. Moreover, the guide groove 59a includes the second guide groove that gently draw an obtuse and shallow arc to the right side as it goes downward to rotate the posture of the suction-pad supporting member 54 and the pair of suction pads 52 by approximately 90 degrees, and the first guide groove and the second guide groove communicate with each other and are coupled to each other.

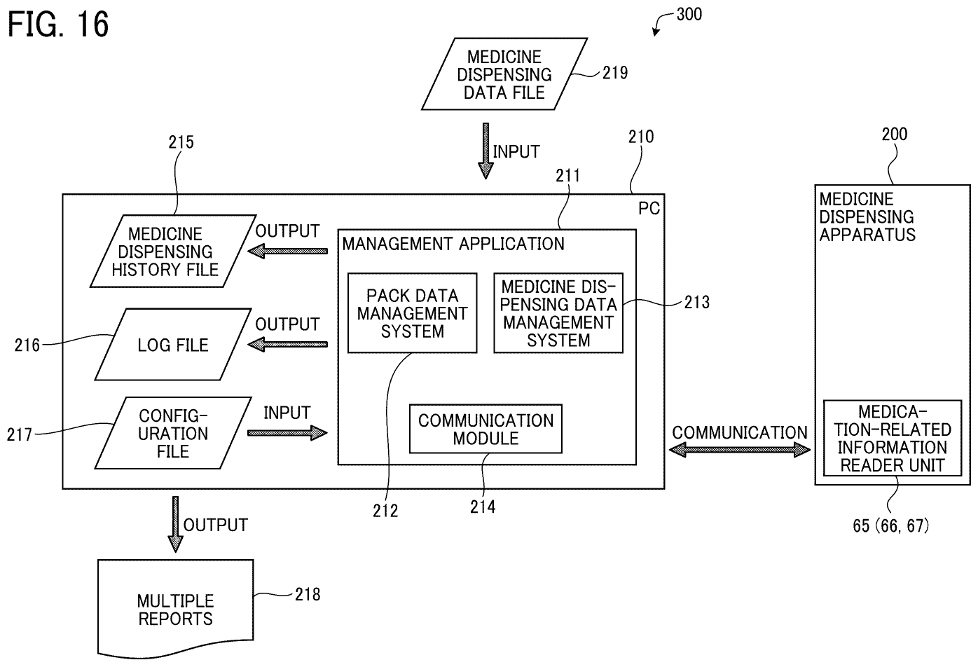

As illustrated in FIGS. 9A and 9B, the carriage 50 is provided with an upper QR code reader 66 that is an example of a medication-related information reader unit 65 or a pack data reader that read the QR CODE that indicates the medication-related information 6c (see FIG. 5A and FIG. 5B) displayed on, for example, the medicine package 2 stored in the cartridge 10. The upper QR code reader 66 has an upper reader unit 66a that reads the medication-related information 6c at an upper portion thereof, and also serves as a medication-related information reader unit 65 as will be described later in detail with reference to FIG. 15 and FIG. 16. The upper QR code reader 66 is attached to a side of the carriage 50. The upper QR code reader 66 is also used to read the QR CODE that indicates the medication-related information 6c displayed on the label (see FIG. 6A and FIG. 6B) pasted to the left support portion 13 of the pack pickup slot 17 in one of the multiple cartridges 10. Cases are described below in which the QR CODE that indicates the medication-related information 6c is read by the upper reader unit 66a of the upper QR code reader 66 immediately before the medicine package 2 is picked up from one of the multiple cartridges 10 by the carriage 50.

As illustrated in FIG. 9A and FIG. 9B, the carriage 50 is provided with a lower QR code reader 67 that is an example of the medication-related information reader unit 65 or the pack data reader that reads the QR CODE on the label 7 pasted onto the subdivision box 34 described above with reference to FIG. 4A and FIG. 4B to indicate the medication-related information 6c. The lower QR code reader 67 has the lower reader unit 67a, which is an example of the medication-related information reader unit 65 or a pack data reader to read medicine-dispensing data, at a lower position, and is attached to a side of the carriage 50 under the upper QR code reader 66. Cases are described in which the QR CODE on the subdivision box 34 that indicates the medication-related information 6c is read by the lower reader unit 67a of the QR code reader 67 immediately before one of the multiple medicine packages 2 picked up from one of the multiple cartridges 10 is dispensed to one of the multiple subdivision boxes 34 of the medicine dispensing tray 30.

The operation of the carriage 50 will be described below in detail with reference to FIG. 10 to FIG. 12C. For the sake of explanatory convenience, it is assumed in the present embodiment that, due to the operation of the conveyor 90 illustrated in FIG. 1A and FIG. 1B, the carriage 50 is arranged below the cartridge tray 20 provided for the upper one of the pair of drawers 80 arranged at an upper portion and a lower portion of the housing 199 illustrated in FIG. 1A and FIG. 1B. In the present embodiment, it is assumed that the cartridges illustrated in FIG. 5A and FIG. 5B and the cartridge trays illustrated in FIG. 1A and FIG. 1B are used as the cartridges 10 and the cartridge trays 20, respectively.

In FIG. 10, the carriage 50 can be moved by the conveyor 90 as illustrated in FIG. 1A and FIG. 1B in the X-axis direction and the Y-axis direction in the lower region of one of the multiple cartridges 10 and the cartridge tray 20. Firstly, as illustrated in FIG. 10, the carriage 50 moves to a position under the cartridge tray 20 that holds the cartridges 10 containing the medicine packages 2 to be picked up. In other words, the upper reader unit 66a of the upper QR code reader 66 in the carriage 50 is approximately directly below the cartridge tray 20 and one of the multiple cartridges 10, and the QR CODE that indicates the medication-related information 6c on the medicine package 2 stored at the bottom of one of the multiple cartridges 10 can be scanned and read by the upper reader unit 66a of the upper QR code reader 66 through a scanning range 9 within the rectangular through opening 21 of the cartridge tray 20. The carriage 50 that is positioned as above reads the QR CODE that indicates the medication-related information 6c displayed on the medicine package 2, using the upper reader unit 66a of the upper QR code reader 66.

Subsequently, the carriage 50 is slightly moved by the conveyor 90 as illustrated in FIG. 1A and FIG. 1B from the position as illustrated in FIG. 10 to the right in the X-axis direction as illustrated in the 11A. As a result, the carriage 50 moves to a position where one of the multiple medicine packages 2 at the bottom can be picked up from the same cartridge 10, and stops moving. Under such conditions, the drive motor 63 of the suction unit lifting and lowering unit is stopped, and the pair of suction pads 52 are positioned under the position of the top face of the pickup device, which indicates the position of the top face of the picking-up frame 50a of the carriage 50. Subsequently, as illustrated in FIG. 11B, the pair of suction pads 52 are moved upward by the operation of the motor 63, and enters from the pack pickup slot 17 between the right support portion 12 and the left support portion 13. Then, as soon as the pair of suction pads 52 contact one of the multiple medicine packages 2 at the bottom of one of the multiple cartridges 10, and the pair of suction pads 52 suck that medicine package 2. At that time, the negative-pressure generator 45 has been driven in advance so as to generate a negative pressure, and can suck up the medicine package 2.

Subsequently, as illustrated in FIG. 11C, as the drive motor 63 is reversely operated, the pair of suction pads 52 move downward while sucking one of the medicine packages 2 by the pair of suction pads 52, and the front end of one of the medicine packages 2 is pulled out from the cartridge 10. The front end of the medicine package indicates a side of the medicine package to be absorbed or sucked up by the pair of suction pads 52.

Subsequently, as illustrated in FIG. 11D, by the operation of the conveyor 90, the carriage 50 is moved in the X-axis direction, which is the lateral direction, and the rear end of one of the multiple medicine packages 2 is drawn out or picked up from one of the multiple cartridges 10. Subsequently, as illustrated in FIG. 11E and FIG. 11F, by the operation of the drive motor 63, one of the multiple medicine packages 2, which is approximately in a horizontal state and is sucked and held by the pair of suction pads 52, is rotated by substantially 90 degrees to change the posture to an approximately vertical or upright posture. In such rotational operation, the guide axis 56 that is arranged on the suction-pad supporting member 54 moves along the guide groove 59a of the guide unit 59. Accordingly, the posture of one of the multiple medicine packages 2 can be changed from an approximately horizontal posture to an approximately vertical posture. The above series of operation in the above configuration may be achieved by a series of operations performed by a single drive motor 63.

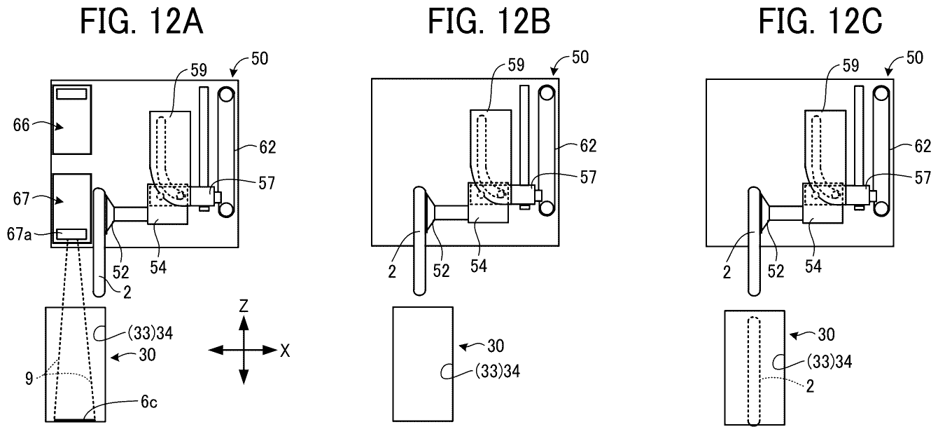

Then, as illustrated in FIG. 12A, the carriage 50 that includes the pair of suction pads 52 and holds one of the multiple medicine packages 2 in a substantially vertical posture is carried by the conveyor 90 to a predetermined position. When the lower reader unit 67a of the lower QR code reader 67 in the carriage 50 comes to the predetermined position at which the QR CODE that indicates the medication-related information 6c and is displayed at the bottom of predetermined one of the multiple subdivision boxes 34 or rooms 33 of one of the multiple medicine dispensing trays 30 moves to the scanning range 9, the lower reader unit 67a reads the QR CODE that indicates the medication-related information 6c.

Subsequently, the carriage 50 is slightly moved by the conveyor 90 as illustrated in FIG. 1A and FIG. 1B from the position as illustrated in FIG. 12A to the right in the X-axis direction as illustrated in the 12B. As a result, the carriage 50 moves to a position where the picked-up medicine package 2 can be insertable into to a predetermined one of the multiple subdivision boxes 34 or rooms 33 of the same medicine dispensing tray 30. Then, the carriage 50 stops moving. Once the carriage 50 is carried to a position substantially directly above a predetermined one of the multiple subdivision boxes 34 or rooms 33 of one of the multiple medicine dispensing trays 30 into which the picked-up medicine package 2 is insertable, the negative-pressure generator 45 is driven only for a short time in order to generate a positive pressure from the negative pressure. Accordingly, the pressurized air is blown from the pair of suction pads 52 to the medicine package 2. As a result, the suction holding of one of the multiple medicine packages 2 by the pair of suction pads 52 is released, and one of the multiple medicine packages 2 is inserted into a desired one of the multiple subdivision boxes 34 or a desired one of the multiple rooms 33 of the multiple medicine dispensing trays 30 (see, for example, FIG. 12C).

After the above-described operation is performed several times and a desired one of the multiple medicine packages 2 is inserted into desired one of the rooms 33 (or the subdivision boxes 34) that is at a predetermined position of one of the multiple medicine dispensing trays 30, one of the medicine dispensing trays 30 is ejected to the outside of the medicine dispensing apparatus 200 through the third gate 43 (see FIG. 1A and FIG. 1), and is received by a staff or the like in a day-care center or nursing home or a medication assistant.

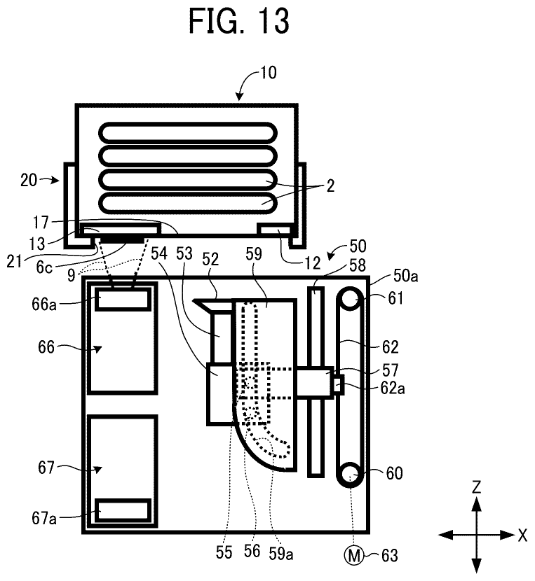

Some operations to be performed when the QR CODE that is displayed on one of the multiple cartridges 10 and indicates the medication-related information 6c, as illustrated in FIG. 6A and FIG. 6B, is read by the upper reader unit 66a of the upper QR code reader 66, as illustrated in FIG. 9A and FIG. 9B, are described with reference to FIG. 13. The cartridge 10 illustrated in FIG. 6A and FIG. 6B is different from the cartridge 10 as illustrated in FIG. 5A and FIG. 5B in that the position at which the QR CODE that indicates the medication-related information 6c is displayed is changed from the bag 2a of the medicine package 2 to the bottom wall of the left support portion 13 of one of the multiple cartridges 10.

In order to read the QR CODE displayed on the bottom wall of the left support portion 13 of one of the multiple cartridges 10 to indicate the medication-related information 6c, as illustrated in FIG. 13, the carriage 50 is moved to the left in the X-axis direction. More specifically, the carriage 50 is moved to a position within the scanning range 9 in which the QR CODE displayed on the bottom wall of the left support portion 13 of one of the multiple cartridges 10 to indicate the medication-related information 6c can be scanned and read by the upper reader unit 66a of the upper QR code reader 66 in the carriage 50. The carriage 50 that is positioned as above reads the QR CODE that indicates the medication-related information 6c displayed on the bottom wall of the left support portion 13 of one of the cartridges 10, using the upper reader unit 66a of the upper QR code reader 66. The operation of the carriage 50 is equivalent to the operation described above with reference to FIG. 11A to FIG. 12B, just except the operation described above with reference to FIG. 13.

As described above, when desired one of the medicine packages 2 is picked up from one of the cartridges 10, the carriage 50 is positioned or arranged under one of the cartridges 10 or the cartridge trays 20, and such desired one of the multiple medicine packages 2 is taken out in the downward direction of one of the multiple cartridges 10. When one of the multiple medicine packages 2 is taken out from the lower side of one of the multiple cartridges 10 as described above, the next one of the multiple medicine packages 2 automatically moves downward or toward the pack pickup slot 17 due to the self-weight of the movable board 16 and the multiple medicine packages 2 left in one of the multiple cartridges 10. Due to such a configuration, the carriage 50 can perform the same operation with a relatively simple configuration regardless of the number of the multiple medicine packages 2 left in one of the multiple cartridges 10.

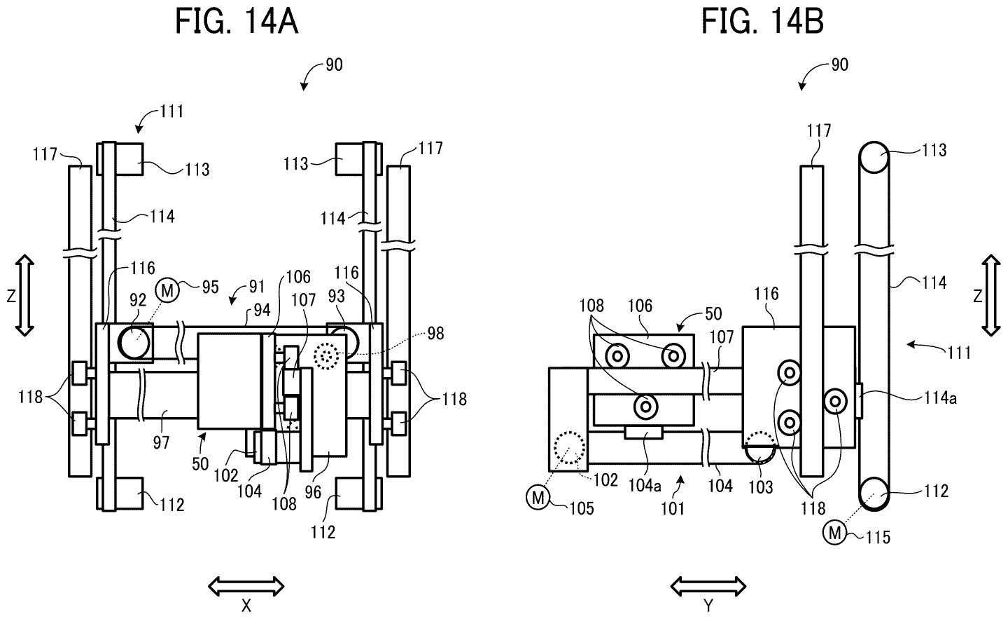

FIG. 14A is a front view of the conveyor 90, illustrating a schematic configuration of the conveyor 90.

FIG. 14B is a side view of the conveyor 90 of FIG. 14A.

As in the configuration or structure of the medicine dispensing apparatus 200 illustrated in FIG. 1A and FIG. 1B, the multiple cartridges 10 are aligned in a row on a plane under the medicine dispensing tray 30 in the Z-axis direction, and the medicine dispensing tray 30 is arranged at an uppermost portion of the housing 199 and further above the upper portions of the multiple cartridges 10. In view of these circumstances, the carriage 50 is configured to move in three directions of the X-axis direction, the Y-axis direction, and the Z-axis direction. As described above, the conveyor 90 moves the carriage 50 in the X-axis direction, the Y-axis direction, and the Z-axis direction in order to convey one of the multiple medicine packages 2 picked up from one of the multiple cartridges 10 by the carriage 50 and pass it to one of the multiple medicine dispensing trays 30.

The carriage 50 is moved in the X-axis direction by an X-axis direction conveyor 91, and the carriage 50 is moved in the Y-axis direction by a Y-axis direction conveyor 101. The carriage 50 is moved in the Z-axis direction by a Z-axis direction conveyor 111. These three conveyors have a similar configuration or structure.

The X-axis direction conveyor 91 includes an X-adaptor 96 attached to the carriage 50, an X-guide unit 97 that guides the carriage 50 in the X-axis direction through the X-adaptor 96, an endless belt 94 looped around a driving pulley 92 and a driven pulley 93, and a drive motor 95 used for the conveyance in the X-axis direction. The drive motor 95 is coupled to the driving pulley 92 through a driving force conveyor such as a gear or a belt. As illustrated in FIG. 14A, three rollers 98 are attached to the X-adaptor 96 so as to clamp the X-guide unit 97. Due to such a configuration, the X-adaptor 96 can roll over the X-guide unit 97. Note also that two of the three rollers 98 are hidden by the carriage 50 and invisible in FIG. 14A. The X-adaptor 96 is fixedly coupled to the endless belt 94 through a belt grip.

When the drive motor 95 is driven to rotate due to the above configuration or structure of the X-axis direction conveyor 91, the driving force is conveyed to the endless belt 94 through the driving force conveyor and the driving pulley 92, and the endless belt 94 runs in rotation. Accordingly, the carriage 50 moves in the X-axis direction along the X-guide unit 97 together with the X-adaptor 96.

The Y-axis direction conveyor 101 includes a Y-adaptor 106 attached to the carriage 50, a Y-guide unit 107 that guides the carriage 50 in the Y-axis direction through the Y-adaptor 106, an endless belt 104 looped around a driving pulley 102 and a driven pulley 103, and a drive motor 105 used for the conveyance in the Y-axis direction. The drive motor 105 is coupled to the driving pulley 102 through a driving force conveyor such as a gear or a belt. Three rollers 108 are attached to the Y-adaptor 106 so as to clamp the Y-guide unit 107. Due to such a configuration, the Y-adaptor 106 can roll over the Y-guide unit 107. The Y-adaptor 106 is coupled and fixed to the endless belt 104 through the belt grip 104a.

When the drive motor 105 is driven to rotate due to the above configuration or structure of the Y-axis direction conveyor 101, the driving force is conveyed to the endless belt 104 through the driving force conveyor and the driving pulley 102, and the endless belt 104 runs in rotation. Accordingly, the carriage 50 moves in the Y-axis direction along the Y-guide unit 107 together with the Y-adaptor 106.

The Z-axis direction conveyor 111 includes a pair of Z-adaptors 116 attached to both ends of the X-guide unit 97 in the X-axis direction, a pair of Z-guide units 117 that guides the carriage 50 in the Z-axis direction through the X-guide unit 97 and the pair of Z-adaptors 116, an endless belt 114 looped around a driving pulley 112 and a driven pulley 113, and a drive motor 115 used for the conveyance in the Z-axis direction. The drive motor 115 is coupled to the driving pulley 112 through a driving force conveyor such as a gear or a belt. In the Z-axis direction conveyor 111, the driving pulley 112, the driven pulley 113, and the endless belt 114 are arranged on both sides in the X-axis direction. The drive motor 115 is provided for only one of the pair of driving pulleys 112. Three rollers 118 are attached to the Z-adaptor 116 so as to clamp the Z-guide unit 117. Due to such a configuration, the Z-adaptor 116 can roll over the Z-guide unit 117. The pair of Z-adaptors 116 are coupled and fixed to the pair of endless belts 114 through a pair of belt grips 114a, respectively.

When the drive motor 115 is driven to rotate due to the above configuration or structure of the Z-axis direction conveyor 111, the driving force is conveyed to the endless belt 114 through the driving force conveyor and the driving pulley 112, and the endless belt 114 runs in rotation. Accordingly, the carriage 50 moves in the Z-axis direction along Z-guide unit 117 together with the X-guide unit 97 and the Z-adaptor 116.

In FIG. 14A and FIG. 14B, the carriage 50 moves in the triaxial directions including the X-axis direction, the Y-axis direction, and the Z-axis direction. However, no limitation is indicated thereby. For example, when the cartridge 10 is arranged above the carriage 50 and the medicine dispensing tray 30 is arranged below the carriage 50, the carriage 50 only needs to move in the X-axis direction and the Y-axis direction. In such cases, the number of axes of motion can be reduced by one.

In the above embodiments, the QR code reader that is an example of a pack data reader is divided into two sections including the upper QR code reader 66 provided with the upper reader unit 66a and the lower QR code reader 67 provided with the lower reader unit 67a. However, no limitation is indicated thereby, and one integrated QR code reader may be used.

As will be described later, the reading operation of the QR CODE is controlled to automatically start upon detecting the storing of one of or both one of the multiple cartridges 10 and one of the multiple medicine dispensing trays 30. The reading operation of the QR CODE may start immediately before one medicine pack is picked up from one of the multiple cartridges 10 or immediately before medicines are dispensed to one of the multiple medicine dispensing trays 30. The reading operation of the QR code may start at any time specified by an operation made by a user. No limitation is intended thereby in terms of a method for implementation.

In the present embodiment, the QR CODE on the carriage 50 and the QR CODE on each one of the multiple subdivision boxes 34 of the medicine dispensing tray 30 are read, and multiple items of information are stored. Then, such multiple items of information are used to make comparison when medicines are dispensed, as will be described later in detail with reference to FIG. 16.

FIG. 15 is a diagram illustrating the control blocks of the medicine dispensing apparatus 200.

As illustrated in FIG. 15, the medicine dispensing apparatus 200 includes a central processing unit (CPU) that is an example of a controller 150 that controls the operation of, for example, the components or elements of the medicine dispensing apparatus 200. For example, the CPU may be provided with a built-in memory 153 or a built-in timer. The CPU according to the present embodiment may provide notification to a staff or the like at a timing consistent with the program or may instruct the medicine dispensing apparatus 200 to perform particular operation, based on various kinds of input such as the inputs from a sensor as will be described later in detail.

The CPU may have, for example, a computing or control function, and a timer or clocking function. The controller 150 includes a memory 152, and the memory 152 includes a random access memory (RAM) that is referred to as a main memory and a read-only memory (ROM). The ROM stores, for example, a program readable by the above CPU and various kinds of data in advance. Such a program stored in the ROM may be a program used in the flowchart of the controlling processes as will be described later in detail. The above various kinds of data may be, for example, the data about the relation between the multiple medicine packages 2 and the multiple rooms 33 or the multiple subdivision boxes 34 of one of the multiple medicine dispensing trays 30 allocated to each of the patients who take medicines, the data about the relation between the multiple medicine packages 2 and the multiple rooms 33 or the multiple subdivision boxes 34 of one of the multiple medicine dispensing trays 30 assigned to each one of the times of medication, or the data about the relation between the multiple medicine packages 2 and the multiple rooms 33 or the multiple subdivision boxes 34 of one of the multiple medicine dispensing trays 30 sorted according to the order in which medicines are to be taken.

The CPU has an input and output (I/O) port, and a touch panel 151 that serves as a user interface (UI) is electrically connected to that input and output port of the CPU. However, no limitation is intended thereby, and the touch panel 151 may be, for example, a combination of an input device and a display interface such as a combination of a keyboard and a light-emitting diode (LED) display.

The CPU has an input port, and a medicine dispensing tray sensor 156 that detects the type of medicine dispensing tray 30 stored in the medicine dispensing apparatus 200 or determines whether or not there is any medicine dispensing tray 30, and a cartridge sensor 157 that determines whether or not there is any one of the multiple cartridges 10 are electrically connected to the input port of the CPU. As various types of sensors, a pair of drawer gate opening and closing sensors 159a and 159b that detect the opening and closing of the first gate 41 and the second gate 42 and a pair of medicine dispensing tray gate opening and closing sensors 160a and 160b that detect the opening and closing of the third gate 43 and the fourth gate 44 are electrically connected to the input port of the CPU. The medicine dispensing tray sensor 156, the cartridge sensor 157, the pair of drawer gate opening and closing sensor 159a and 159b, and the pair of medicine dispensing tray gate opening and closing sensors 160a and 160b are illustrated in FIG. 15.

To the input port of the CPU, HP sensor 99 for a HP sensor X that detects the home position (HP) of the X-axis direction conveyor 91 in the carriage 50, a HP sensor 109 for a HP sensor Y that detects the home position (HP) of the Y-axis direction conveyor 101 in the carriage 50, a HP sensor 119 for a HP sensor Z that detects the home position (HP) of the Z-axis direction conveyor 111 in the carriage 50 are electrically connected. Further, to the input port of the CPU, a home position (HP) sensor 158 for a HP sensor P, which detects the home positions (HP) of the pair of suction pads 52 of the suction device 51 in the carriage 50 is electrically connected.

The upper QR code reader 66 that serves as the medication-related information reader unit 65 or an upper reader unit 66a and the lower QR code reader 67 that serves as the medication-related information reader unit 65 or a lower reader unit 67a, each of which is arranged on the carriage 50, are electrically connected to the input port of the CPU.

Further, to the input port of the CPU, a cartridge sensor 70 that is an example of a container sensor and detects the attachment and detachment of the cartridge 10 to the housing 199 of the medicine dispensing apparatus 200 is electrically connected. The container sensor and the cartridge sensor 70 will be described later in detail.

To the output port of the above CPU, the drive motor 95 for the X-axis direction conveyor 91, the drive motor 105 for the Y-axis direction conveyor 101, the drive motor 115 for the Z-axis direction conveyor 111, and the drive motor 63 used to change the posture or attitude of the pair of suction pads 52 are electrically connected to the input port of the CPU through various kinds of motor drivers X, Y, Z, and P, respectively. Moreover, to the output port of the above CPU, the negative-pressure generator 45 that is an example as an ejector valve and an actuator used for the negative pressure generator is electrically connected through a driver used for a negative-pressure generator. To the output port of the CPU, a notification unit 154 may be electrically connected. The notification unit 154 reports what sort of state or conditions the components or elements of the medicine dispensing apparatus 200 are in by means of, for example, the light emitted from a light-emitting diode (LED) and the sound or vibration including voice. Moreover, the notification unit 154 may be provided with, for example, a loudspeaker or a light that indicates that the medicines are to be taken so that the staff or the like away from the medicine dispensing apparatus 200 can be notified of such a time of medication.

The external medicine information is also input to the CPU through an input and output (I/O) interface, and is stored in the memory 152. For example, the external medicine information is used for the allocation of medicines to patients who take medicines. For example, the LEDs 25a1 to 25d5 of the drawer 80 may be electrically connected to each other.

Once the input data from the touch panel 151 and various kinds of signals from various types of sensors or the HP sensors 99, 109, 119, and 158 are input to the CPU, a command signal is newly output from the CPU. In other words, the CPU according to the present embodiment outputs a command signal used to control the audio device or the optical device of the display device of the touch panel 151 including the above notification unit 154, the LEDs 25a1 to 25d5, the negative-pressure generator 45, the drive motor 63, the drive motor 95, the drive motor 105, the drive motor 115, or the multiple drives that correspond to the multiple LEDs.

The HP sensor 158 for the HP sensor P and the drive motor 63 that outputs power through the motor driver P are used to control or drive the mechanism for moving the suction device to move upward and downward. The CPU according to the present embodiment executes various kinds of control operation as will be described later in detail in the following description or the flowchart of the controlling processes.

FIG. 16 is a diagram illustrating the control blocks of a medication support device 300.

As illustrated in FIG. 16, the medication support device 300 is provided with the above-described medicine dispensing apparatus 200 and a personal computer (PC) 210 coupled to the medicine dispensing apparatus 200. Such coupling enables communication such as data transmission and data reception. The PC 210 includes five elements known in the art. In other words, the PC 210 is provided with, for example, a control device, a processor, a memory, an input device, and an output device. The above control device of the PC 210 is provided with a central processing unit (CPU), and executes a program or gives instructions to other devices. The above processor of the PC 210 executes a program or performs computation. The above memory of the PC 210 is provided with, for example, a main memory and an auxiliary memory, and stores data such as programs or texts. The above input device according to the present embodiment includes, for example, a mouse, a keyboard, a microphone, and sends data or instructions to the computer. The output device includes, for example, a display, a printer, a loudspeaker, and outputs the data output from the computer.

The PC 210 fulfills the function of the medicine dispensing apparatus 200, and serves as a sort of host computer that manages and supports the medicine dispensing apparatus 200 in order to handle the above technical problems and other various kinds of possible problems to be solved in the embodiments of the present disclosure. The PC 210 is connected to a terminal in a pharmacy or the like at which the medicine is supplied, through the network.

The pack data management system 212 provided for the management application 211 reads and manages the medication-related information of the medicine pack. The medicine-dispensing data management system 213 provided for the management application 211 reads and manages the medicine-dispensing data including at least the name of a patient who takes medicines and the times of medication.

For example, the pack data management system 212 and the medicine-dispensing data management system 213 may be implemented as the management application 211 in the PC 210. As illustrated in FIG. 16, a system may include the medicine dispensing apparatus 200 and the PC 210 and performs management by communicating with the medicine dispensing apparatus 200. The management application 211 reads the medicine-dispensing data file 219 that is externally produced at a pharmacy or the like where medicines are supplied based on the prescription given by a doctor and includes, for example, times at which medicines are dispensed and medicine information for each patient who takes medicines. The management application 211 reads the data output from the configuration file 217 in which, for example, the setting information once applied to the PC 210 is recorded.

For example, a file to be output as log file 216 according to what has been changed or a medicine dispensing history file 215 in which medicine dispensing history is tracked is the data to be output from the management application 211 as necessary. Further, the multiple reports 218 are output as necessary from the PC 210 through the management application 211. The functions such as of the management application 211 of the PC 210 may be arranged in the medicine dispensing apparatus 200.

In other words, in the medicine-dispensing data management system 213, the results of medicine dispensing or the change history are stored as record. By so doing, the actual medicine dispensing results are stored as traceability information. This enables a review when a problem occurs.

The pack data management system 212 performs management based on the medication-related information of the medicine pack including at least the name of a patient who takes medicines and the times of medication. However, no limitation is indicated thereby, and a supplementary explanation of the operation of, for example, the medicine dispensing apparatus 200 described as above is given below. As illustrated in FIG. 9A and FIG. 9B, the carriage 50 is provided with the upper QR code reader 66 and the lower QR code reader 67 in the medicine dispensing apparatus 200. The carriage 50 moves close to one of the multiple cartridges 10 that stores a medicine pack such as the medicine package 2 and the bound medicine packages 2A, and the QR CODE that indicates the medication-related information 6c can be read by the upper reader unit 66a of the upper QR code reader 66.

When the medication-related information 6c is indicated on the surface of the medicine package 2 as illustrated FIG. 5B, the QR CODE is visible through the pack pickup slot 17 as illustrated in FIG. 10, and the QR code is read by the upper reader unit 66a of the upper QR code reader 66. Even when the medication-related information 6c is displayed on the left support portion 13 on the bottom wall of one of the multiple cartridges 10 as illustrated in FIG. 13, the medication-related information 6c is displayed around the pack pickup slot 17. Accordingly, the QR CODE that indicates the medication-related information 6c can be read by the upper reader unit 66a of the upper QR code reader 66 in a similar manner to the above.

As illustrated in FIG. 12A, also when the carriage 50 moves to a position above desired one of the multiple subdivision boxes 34 of the medicine dispensing tray 30 while holding one of the multiple medicine packages 2 picked up from one of the multiple cartridges 10, the QR CODE that indicates the medication-related information 6c can be read by the lower reader unit 67a of the lower QR code reader 67 in a similar manner to the above. Accordingly, the data read by the upper QR code reader 66 or the lower QR code reader 67 is sent to the pack data management system 212 provided for the PC 210, through the communication module 214.

The carriage 50 is provided with the upper QR code reader 66 and the lower QR code reader 67, the name of a patient who takes medicines and the current position of the cartridge 10 in which the medicine pack to be taken by the patient who takes medicines can be detected by the movement of the carriage 50 in the medicine dispensing apparatus 200 (see, for example, FIG. 1A and FIG. 1). In other words, when the QR CODE on one of the multiple cartridges 10 is read by the upper QR code reader 66 to obtain the position coordinates of the cartridge 10 in the medicine dispensing apparatus 200 corresponding to the current position of the cartridge 10, the position coordinates of the carriage 50 corresponding to the current position of the cartridge 10 can be linked to the QR CODE that indicates the medication-related information 6c. In the position coordinates of the cartridge, for example, X, Y, and Z indicate the rows, columns, and stages, respectively.

However, the medication-related information that is read by the upper QR code reader 66 or the lower QR code reader 67 turns to indefinite information if a medicine pack is manually and directly taken out from the cartridge 10 or a medicine pack is manually and directly supplied to the cartridge 10. For this reason, the medication-related information has to be updated. Otherwise, in a worst case scenario, medicines are erroneously dispensed. Accordingly, when the power of the medicine dispensing apparatus 200 is turned on or turned off, when medicines are dispensed again after the medicine dispensing operation is once completed, or when there is a possibility that the cartridge 10 is replaced, the medication-related information has to be read again. However, when there are a large number of cartridges 10 and the medication-related information of all the cartridges 10 is read every time medicines are dispensed, the length of time required to perform a reading operation gets longer, and it takes a long time to dispense medicine. In order to avoid such a situation, the attachment or detachment of the cartridge 10 is detected using a sensor, and the medication-related information of only the cartridge 10 with changes due to a loading or unloading operation is read again. The attachment or detachment of cartridges may be referred to as the loading or unloading of the cartridges in the following description. By so doing, the length of time required to perform a reading operation can significantly be reduced.

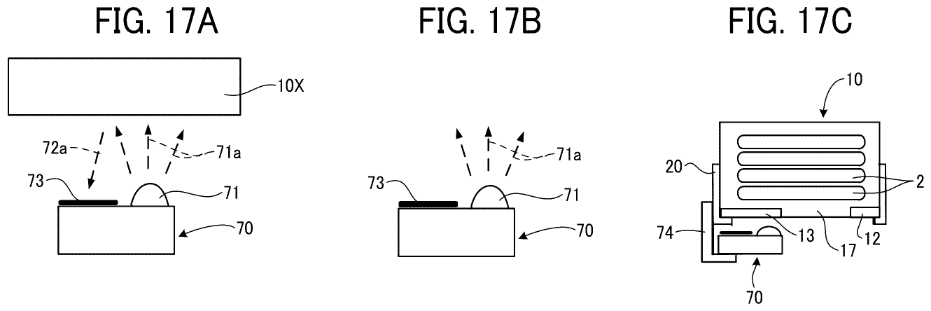

FIG. 17A, FIG. 17B, and FIG. 17C are schematic diagrams of a cartridge sensor 70 that detects the attachment and detachment of the cartridge 10.

As illustrated in FIG. 17A, a cartridge 10X that is an object to be detected is assumed, and such a cartridge is detected by an optical sensor such as a reflective photosensor that is an example of the container sensor. The cartridge sensor 70 that includes an optical sensor emits detection lights 71a from a light emitter 71, and receives reflection light 72a from that cartridge 10X at a photoreceptor 73 when the cartridge 10X is present. By so doing, the presence or absence of the cartridge 10X, which is an object to be detected, can be detected. By contrast, when there is no cartridge 10X, which is an object to be detected, as illustrated in FIG. 17B, the reflection light of the detection light 71a does not enter the photoreceptor 73. Due to such a configuration, the absence of the cartridge 10X, which is an object to be detected, can be detected.

As illustrated in FIG. 17C, the cartridge sensor 70 with an optical sensor is fitted and fixed to the cartridge tray 20, having, for example, a fitting plate 74 therebetween, to detect the attachment and detachment of the cartridge 10. The cartridge sensor 70 is fitted to the cartridge tray 20 using the fitting plate 74 so as not to interfere with, for example, the carriage 50 at the time of the QR-code reading operation using the upper reader unit 66a of the upper QR code reader 66 illustrated in FIG. 10 and FIG. 13.

The cartridge sensor 70 is not limited to the above optical sensor, and may use a distance sensor to check the changes in the distance from the cartridge 10. Due to such a configuration, the attachment or detachment of the cartridge 10 can be detected. Alternatively, the cartridge sensor 70 may use a weight sensor to detect changes in the weight of the cartridge 10. Due to such a configuration, the attachment and detachment of the cartridge 10 can be detected. The cartridge sensor 70 is not limited to the optical sensor, the distance sensor, or the weight sensor as described above, and may be, for example, a push switch that contacts the cartridge 10 to detect the attachment or detachment of the cartridge 10.

An embodiment in which the attachment and detachment of the cartridge 10 is detected using the cartridge sensor 70, which is composed of an optical sensor and is provided for each one of the cartridges 10, is described below with reference to FIG. 18A-1, FIG. 18A-2, FIG. 18B-1, FIG. 18B-2, and FIG. 19.

FIG. 18A-1 and FIG. 18B-1 are diagrams of the cartridge tray 20 to which the cartridge 10 is not yet attached.

FIG. 18A-2 and FIG. 18B-2 are diagrams of the cartridge tray 20 to which the cartridge 10 is attached.

FIG. 18A-1 is a sectional view of the cartridge tray 20 to which the cartridge 10 is not yet attached and elements around the cartridge tray 20.

FIG. 18B-1 is a bottom view of the cartridge tray 20 to which the cartridge 10 is not yet attached.

FIG. 18A-2 is a sectional view of the cartridge 10, the cartridge tray 20 to which the cartridge 10 is not yet attached, and elements around the cartridge tray 20.

FIG. 18B-2 is a bottom view of the cartridge tray 20 to which the cartridge 10 is attached.

FIG. 19 is a bottom view of the multiple cartridge trays 20 on each of which the cartridge sensor 70 is mounted.

As illustrated in FIG. 18A-2 and FIG. 18B-2, when the cartridge 10 is attached and set on the cartridge tray 20, the cartridge sensor 70 mounted on the outer bottom face of the cartridge tray 20 detects the bottom face of the cartridge 10. Accordingly, it is possible to monitor that the cartridge 10 is attached and set on the cartridge tray 20.

As described above, by arranging the cartridge sensor 70 on the cartridge tray 20, the loading or unloading of each cartridge 10 on the cartridge tray 20 can be checked. The multiple cartridge trays 20 may be combined together as illustrated in FIG. 19.

In the present embodiment described with reference to FIG. 19, the loading or unloading of each cartridge 10 is detected, and the cartridge 10 with changes due to an operation can be monitored with a high degree of accuracy. On the other hand, as a sensor is provided for each one of the cartridges 10, the cost increases, and electrical wiring has to be done for each container sensor such as the cartridge sensor 70.

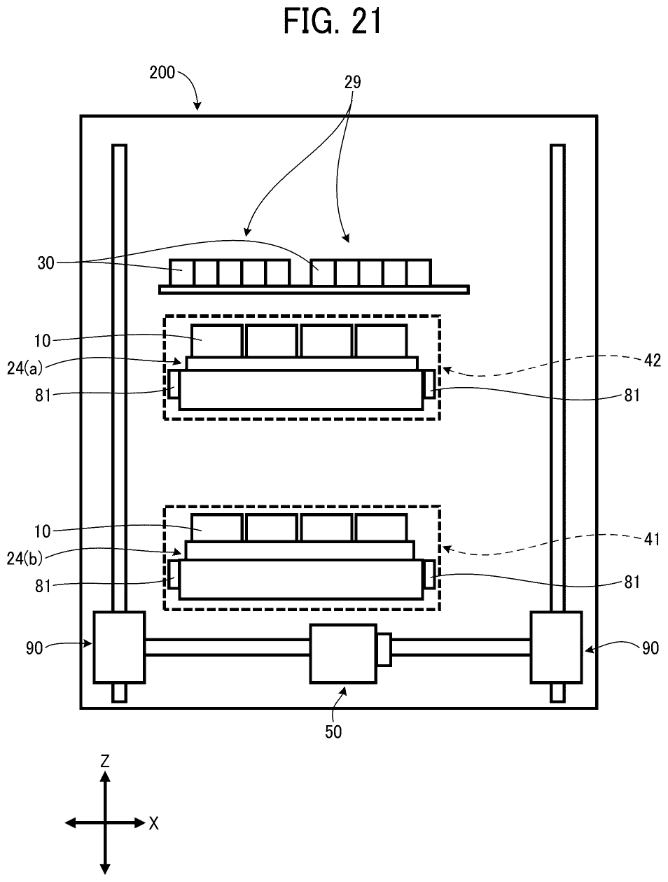

An embodiment in which a container sensor is arranged to detect the attachment and detachment of each container is described below with reference to FIG. 20A, FIG. 20B, and FIG. 21.

FIG. 20A is a diagram illustrating an operation to detect that a group of integrated cartridges 24 illustrated in FIG. 20B is not yet attached to a cartridge-tray placement unit 25, using the cartridge sensor 70.

FIG. 20B is a diagram illustrating an operation to detect that the group of integrated cartridges 24 is attached to the cartridge-tray placement unit 25, using the cartridge sensor 70.

The group of integrated cartridges 24 illustrated in FIG. 20B is attached to or detached from the cartridge-tray placement unit 25 in such a manner that multiple cartridges 10 (i.e., nine cartridges in FIG. 20B) are formed as a single integrated unit.

As illustrated in FIG. 20A, the cartridge sensor 70 is provided for the cartridge-tray placement unit 25, and the group of integrated cartridges 24A and the group of integrated cartridges 24B are placed in the medicine dispensing apparatus 200 illustrated in FIG. 21. Due to such a configuration, the placement of a cartridge can be detected. The container sensor that is used in the present embodiment adopts a sensor equivalent to that of the cartridge sensor 70.

FIG. 21 is a diagram illustrating the medicine dispensing apparatus 200 in which the management of each cartridge tray 20 is performed separately.

The group of integrated cartridges 24 is divided into the group of integrated cartridges 24A and the group of integrated cartridges 24B. When the group of integrated cartridges 24A is loaded or unloaded, only the information on the group of integrated cartridges 24A has to be checked again. In other words, the loading or unloading of the group of integrated cartridges 24A is checked again using the cartridge sensor 70, and the medication-related information 6c is scanned and obtained by the upper reader unit 66a of the upper QR code reader 66.

In the present embodiment described with reference to FIG. 20A, FIG. 20B, and FIG. 21, the loading or unloading of the group of integrated cartridges 24A and the group of integrated cartridges 24B into or from the cartridge-tray placement unit 25 is detected by the cartridge sensor 70, and such detection is performed for each cartridge tray 20 rather than for each cartridge 10. Due to such a configuration, the cost of detection can be reduced.

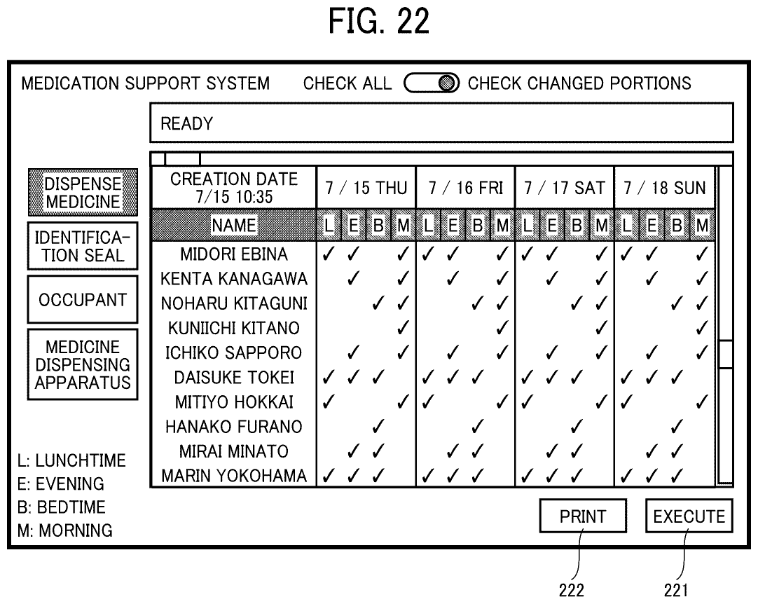

FIG. 22 is a diagram illustrating an operation screen of a management application 211.

From the viewpoint of ensuring security, some users wish to update the data of all the cartridges 10 every time rather than updating only the data at sites with changes. The management application 211 illustrated in FIG. 22 has a function to switch between checking all the cartridges 10 and checking only the cartridges 10 with changes, and enables a user to choose either option. For example, when only the cartridges 10 with changes are to be checked, on the operation screen of the management application 211 illustrated in FIG. 22, the black button is moved to “CHECK CHANGED PORTIONS” displayed at the top using, for example, four keys in a cross arrangement or a computer mouse for dragging operation, and then an execution key 221 is touched or clicked for the selection.

When a high priority is given to ensuring security, “CHECK ALL” is selected and an all-site reading mode is used to update the data of all the cartridges 10. On the other hand, when a high priority is given to increasing productivity, “CHECK CHANGED PORTIONS” is selected and a changed-site reading mode is used to update the data of the sites with changes. When the changed-site reading mode is used, the length of time required for the update can be minimized, and the productivity or efficiency of the medicine dispensing apparatus or the medication support device increases.

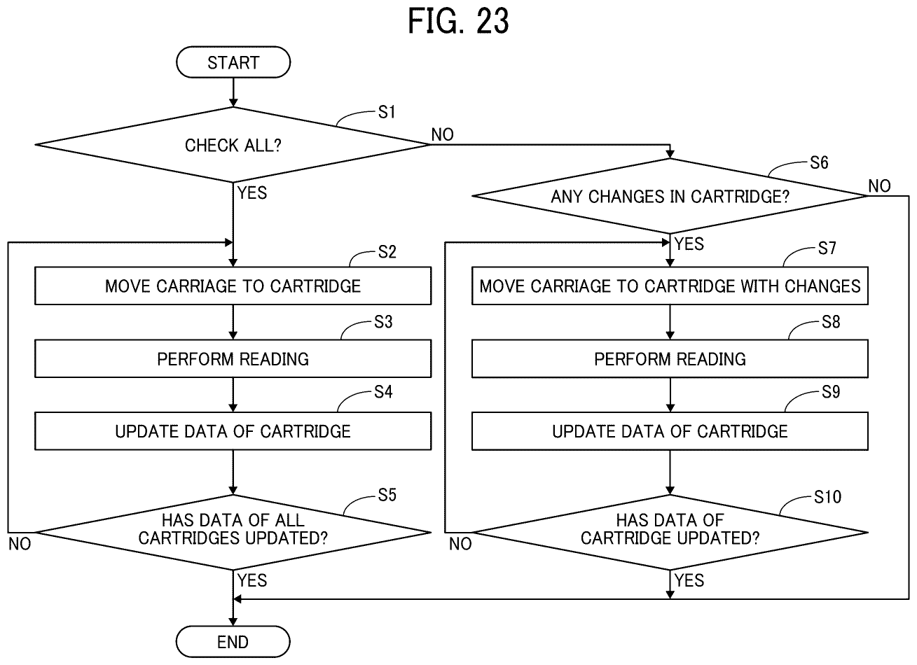

FIG. 23 is a flowchart of the controlling processes as to whether scanning and reading are successfully performed by a medication-related information reading unit such as the upper QR code reader 66.

Firstly, in step S1 of FIG. 23, whether “all check” is to be selected is determined. When “check all” is selected, in step S2, the carriage 50 provided with the upper QR code reader 66 including the upper reader unit 66a is moved to the first one of the cartridges 10 to be checked. After that movement, in step S3, the upper reader unit 66a performs scanning and reading. Subsequently, in step S4, the data of the cartridge 10 is updated. When there is any cartridge 10 that is not yet scanned and read in step S5, in a similar manner to the above, the carriage 50 is moved to the cartridge 10 to be checked next, and this series of operations are performed until the data of all the cartridges 10 is updated.

By contrast, when “check all” is not selected in step S1, in step S6, whether there is any change in some of the cartridges 10 is checked. When it is determined that there is no change in step S6, the operation to update the data of the cartridges 10 is terminated. When “all check” is not selected and there are some changes in the cartridge 10, in step S7, the carriage 50 is moved to the cartridges 10 with changes. In step S8, the upper reader unit 66a performs scanning and reading. In step S9, the data of the cartridge 10 is updated. This series of operations is performed for all the cartridges 10 with changes, and in step S10, whether the data of the cartridges has been updated is determined.

As described above, the data is updated at cartridges with changes. This ensures security, and each data reading operation is minimized.

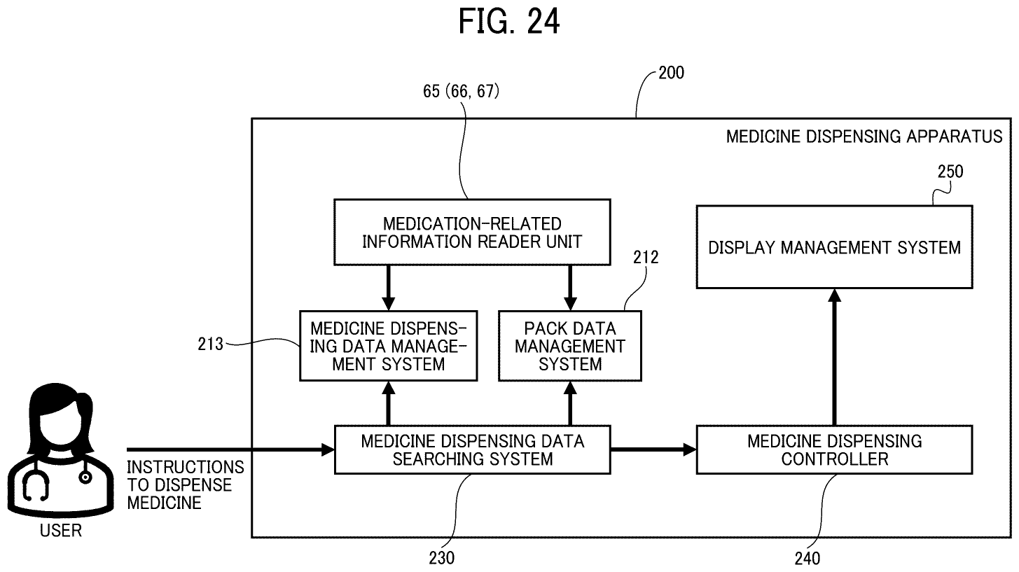

FIG. 24 is a diagram illustrating a system configuration of the medicine dispensing apparatus 200.

When the QR code indicating the medication-related information 6c, which is attached to the cartridge 10, is scanned and read by the medication-related information reader unit 65 including the upper QR code reader 66 and the lower QR code reader 67 (see, for example, FIG. 13), the medicine dispensing apparatus 200 illustrated in FIG. 24 notifies the pack data management system 212 of the QR code data. When the QR code attached to the subdivision box 34 is scanned and read and obtained (see, for example, FIG. 12A), the medicine dispensing apparatus 200 notifies the medicine-dispensing data management system 213 of the QR code data.

Each of the pack data management system 212 and the medicine-dispensing data management system 213 analyzes or processes the QR code data sent from the medication-related information reader unit 65 when necessary, and keeps the data in an appropriate manner.

When a user gives instructions to dispense medicine, such instructions trigger an inquiry to the medicine-dispensing data management system 213 and the pack data management system 212 for an appropriate combination of the position of the cartridge 10 where medicines to be dispensed are stored and the position of the subdivision box 34 to which the medicine pack containing medicines as desired is to be dispensed. The medicine dispensing controller 240 is notified of such a combination, and conducts a medicine dispensing operation based on the obtained combination.

The medicine dispensing controller 240 gives instruction to pick up desired one of the multiple medicine packages 2 from the cartridge 10 indicated in the combination obtained from the medicine-dispensing data searching system 230, such that the medicine package 2 is appropriately dispensed to specified one of the subdivision boxes 34. At the completion of each medicine dispensing operation, the display management system 250 gives instructions to indicate the status of the medicine dispensing apparatus 200 to a user in a timely manner. Depending on the status of the medicine dispensing apparatus 200, for example, “DISPENSING MEDICINE,” “MEDICINE DISPENSED,” or “ERROR” is displayed.

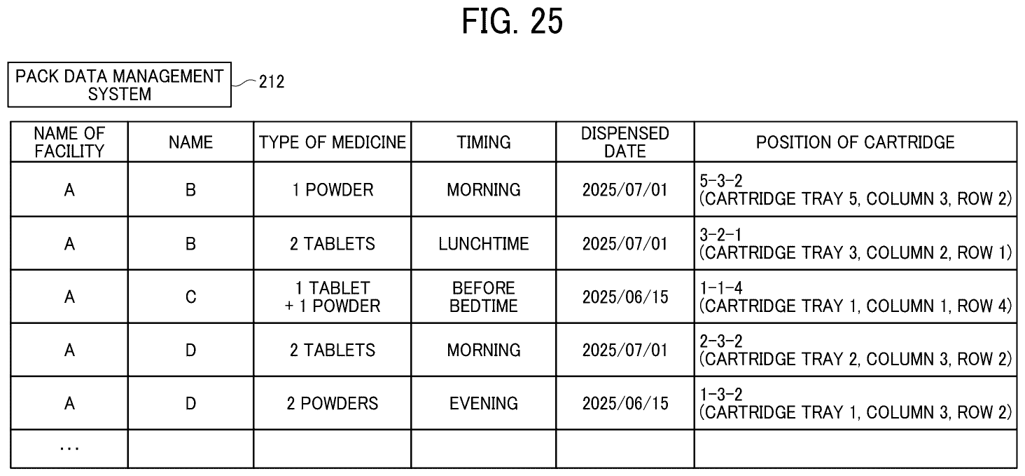

FIG. 25 is a table depicting management data in the pack data management system 212.

As depicted in FIG. 25, the data sent from the medication-related information reader unit 65 includes, for example, the name of the facility, the name (i.e., identifying information) of a patient who takes medicines, the type of medicine, the time of medication, the dispensed date, and the position of the cartridge. Note that a pharmacy prepares and handles medicine packs for a larger number of facilities and it is necessary to distinguish those facilities. This is because the name of the facility is required. Note also that the dispensed date is required to manage the freshness dependent on the creation date. No limitation is indicated thereby, and the data sent from the medication-related information reader unit 65 may include any other kinds of data.

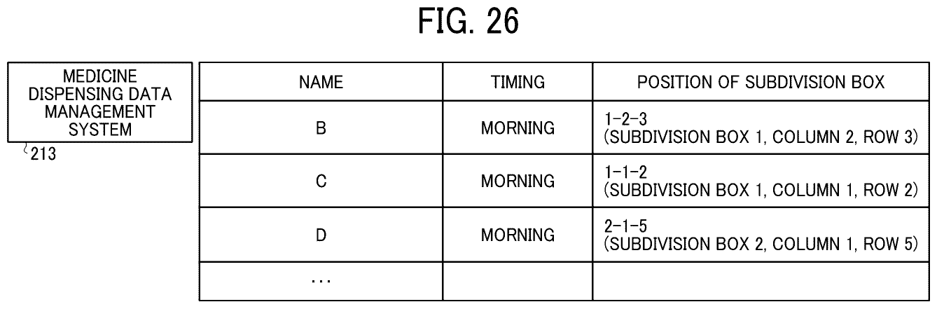

FIG. 26 is a table depicting management data in the medicine-dispensing data management system 213.

As depicted in FIG. 26, the data sent from the medication-related information reader unit 65 includes, for example, the name (i.e., identifying information) of a patient who takes medicines, the time of medication, and the information about the position of the subdivision box 34. In a similar manner to the above description with reference to FIG. 25, no limitation is indicated thereby, and the medicine-dispensing data management system 213 may receive or handle any other kinds of data.

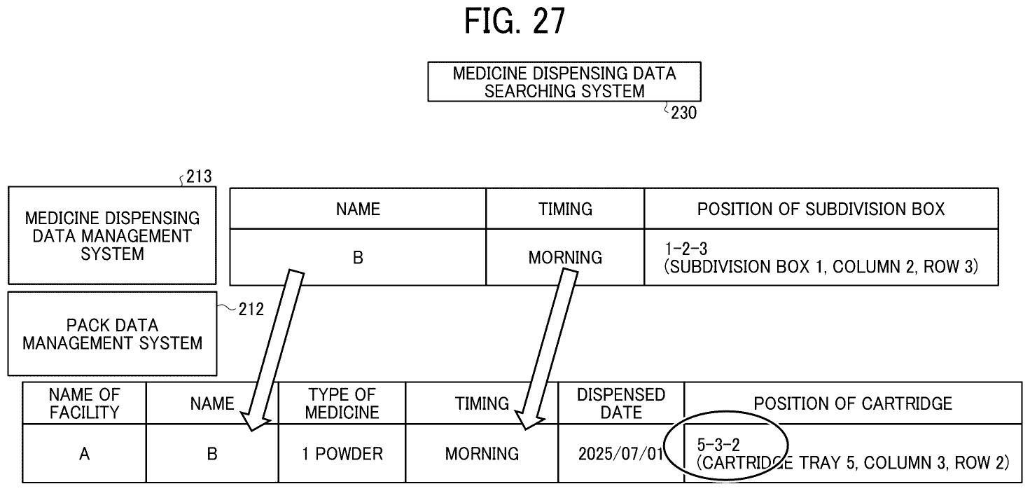

FIG. 27 is a diagram illustrating how a search is carried out in the medicine-dispensing data searching system 230.

In the medicine-dispensing data searching system 230, an inquiry is made to the medicine-dispensing data management system 213 for the information about a person to which medicines are to be dispensed, to obtain data such as names and timings as well as the information about the position of the subdivision box 34 to which medicines are to be dispensed.

Subsequently, a medicine pack to be picked up is searched for based on data such as names and timings from the pack data management system 212, and the position of the cartridge 10 in which the medicine pack is stored is obtained. Then, based on the obtained data, a combination of medicine-dispensing data is generated.

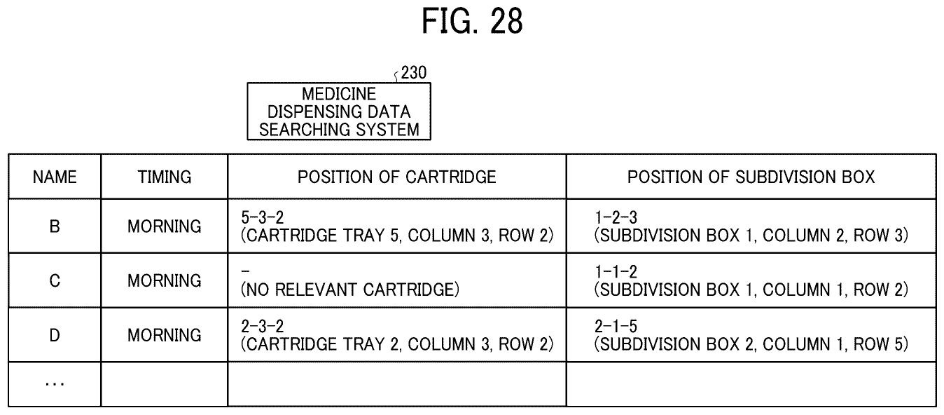

FIG. 28 is a diagram depicting combinations of medicine-dispensing data in the medicine-dispensing data searching system 230.

The combinations of medicine-dispensing data include names, timings, the information about the position of the cartridge 10 in which the medicine pack is stored, and the information about the position of the subdivision box 34 to which medicines are to be dispensed. When any one of the information about the position of the cartridge 10 and the information about the position of the subdivision box 34 is missing in the above case, skipping is adopted during the medicine dispensing operation. In other words, a medicine dispensing operation is performed only when a combination of medicine-dispensing data is complete.

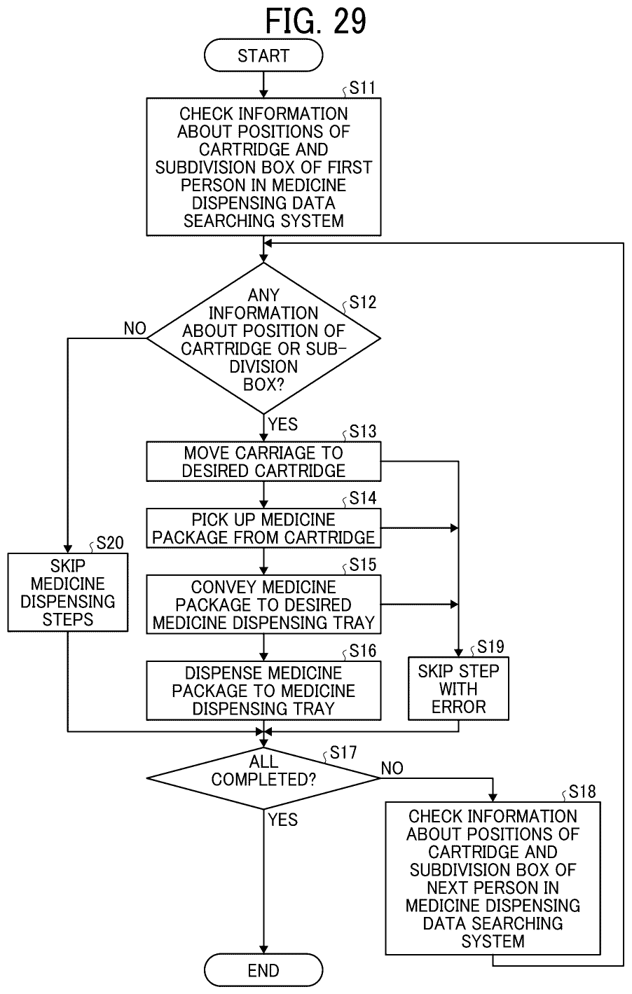

FIG. 29 is a flowchart of a medicine dispensing operation by the medicine dispensing controller 240.

In step S11, the information about the position of the cartridge 10 and the information about the position of the subdivision box 34 of the first person in the medicine-dispensing data searching system 230 are checked. When the information about the position of the cartridge 10 and the information about the position of the subdivision box 34 are confirmed as a pair (YES in step S12), in step S13, the medicine dispensing controller 240 illustrated in FIG. 30 moves the carriage 50 based on the information about the position of the cartridge 10 in which medicines to be dispensed are stored, which is obtained as a result of the search carried out by the medicine-dispensing data searching system 230. Subsequently, in step S14, the medicine package 2 is taken out from the cartridge 10. Subsequently, in step S15, the picked-up medicine package 2 is moved to the subdivision box 34, based on the information about the position of the subdivision box 34 to which medicines are to be dispensed. In step S16, the medicine package 2 is placed in the medicine dispensing tray 30. This series of operations is performed for all the data obtained as a result of the search carried out by the medicine-dispensing data searching system 230. Due to such configurations as described above, medicines can be dispensed to all the subdivision boxes 34 arranged on the medicine dispensing tray 30.

When any one of the information about the position of the cartridge 10 and the information about the position of the subdivision box 34, which are referred to from the medicine-dispensing data searching system 230, is missing (No in step S12), in step S20, medicine dispensing steps are skipped. Due to such a configuration, medicines can automatically be dispensed for all the appropriate combinations of medicine-dispensing data without terminating the operation.

In a similar manner to the above, for example, when an error occurs in step S19 during an operation to pick up a medicine pack in step S13, step S14, or step S15, medicine dispensing steps are skipped, and the next medicine dispensing operation is conducted. Due to such a configuration, all the medicines to be dispensed can be dispensed without terminating the operation of the medicine dispensing apparatus 200 at some midpoint.

When an error occurs in the above configuration, the display management system 250 illustrated in FIG. 24 monitors the error data, and displays error data in a timely manner.

Until the medicine dispensing operation for all the persons is completed by the medicine dispensing controller 240 as depicted in step S17, the operations in step S18 and the following steps are repeated by the medicine-dispensing data searching system 230 based on the information about the position of the cartridge 10 for the next person and the information about the position of the subdivision boxes 34.

FIG. 30 is a diagram illustrating a configuration or structure of the display management system 250.

As illustrated in FIG. 30, the display management system 250 accesses, for example, the medication-related information reader unit 65 including the upper QR code reader 66 and the lower QR code reader 67, the medicine-dispensing data management system 213, the pack data management system 212, the medicine-dispensing data searching system 230, and the medicine dispensing controller 240 to refer to the status of the entirety of the medicine dispensing apparatus 200. By so doing, the status inside the medicine dispensing apparatus 200 is monitored. The display management system 250 includes a status displaying function 251 used to give instructions to display status appropriately as circumstances demand. Moreover, the display management system 250 has an error displaying function 252 used to monitor an error and display where the error occurred and give instructions on how to deal with the error.

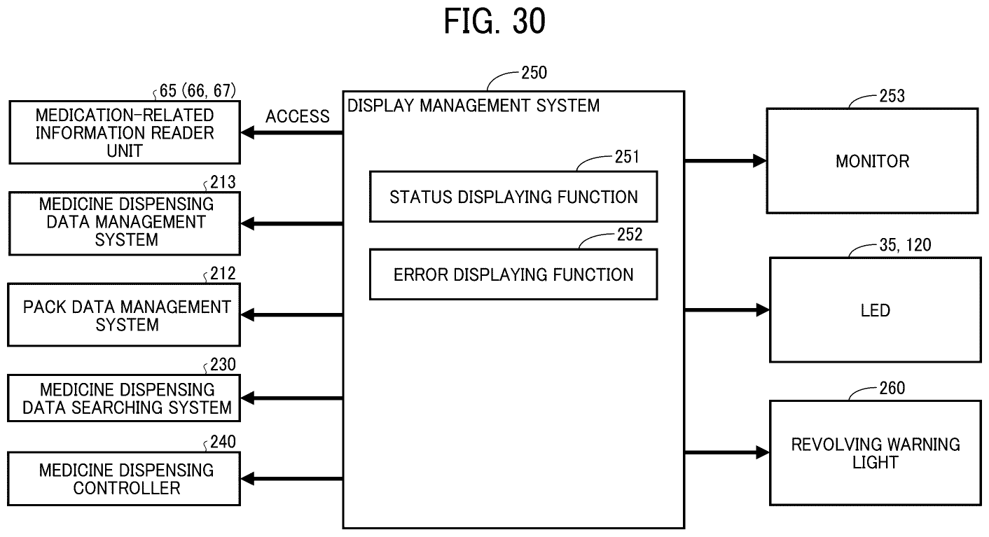

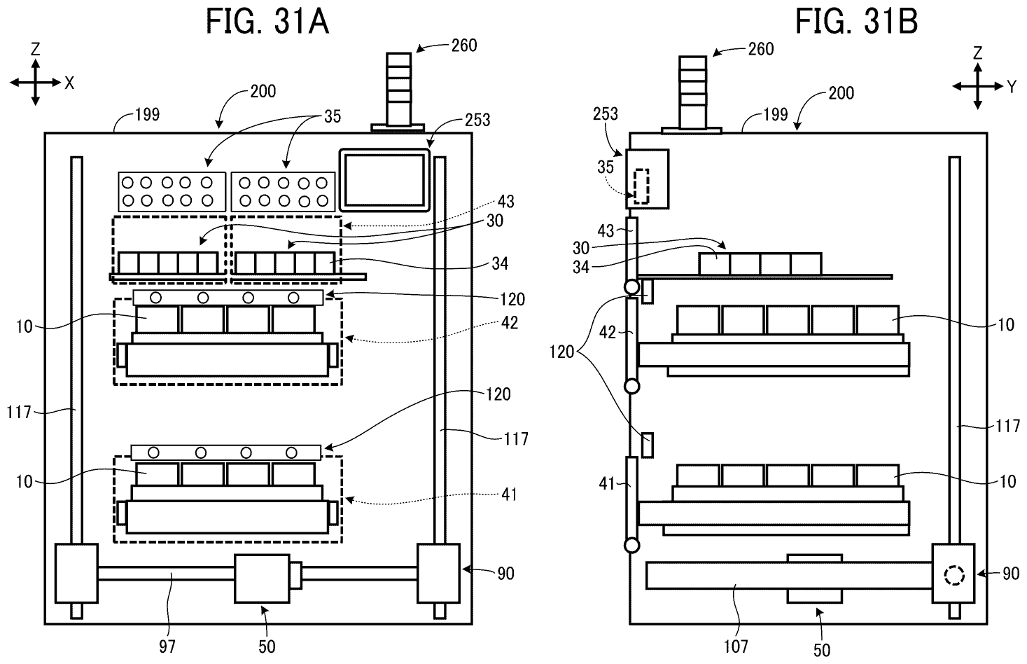

FIG. 31A is a front view of the medicine dispensing apparatus 200, including a display function of the medicine dispensing apparatus 200.

FIG. 31B is a side view of the medicine dispensing apparatus 200 illustrated in FIG. 31A.

As illustrated in FIG. 31A and FIG. 31B, elements depicted in FIG. 30 such as a monitor 253 that display images, a warning light 260, a group of LEDs 120 to indicate the status of cartridge trays 20, and a group of LEDs 35 to indicate the status of the subdivision boxes 34 are electrically connected to the medicine dispensing apparatus 200. As a matter of course, any other desired display methods may be adopted. As illustrated in FIG. 30, elements such as the monitor 253, the warning light 260, the group of LEDs 120 to indicate the status of cartridge trays 20, and the group of LEDs 35 to indicate the status of the subdivision boxes 34 are used to perform control.

Each display unit such as the monitor 253, the warning light 260, the group of LEDs 120 to indicate the status of cartridge trays 20, and the group of LEDs 35 to indicate the status of the subdivision boxes 34 has a function to notify a user of the status of each part of the medicine dispensing apparatus 200 in a timely manner. For example, the system status is displayed in texts on the monitor 253 depicted in FIG. 30.

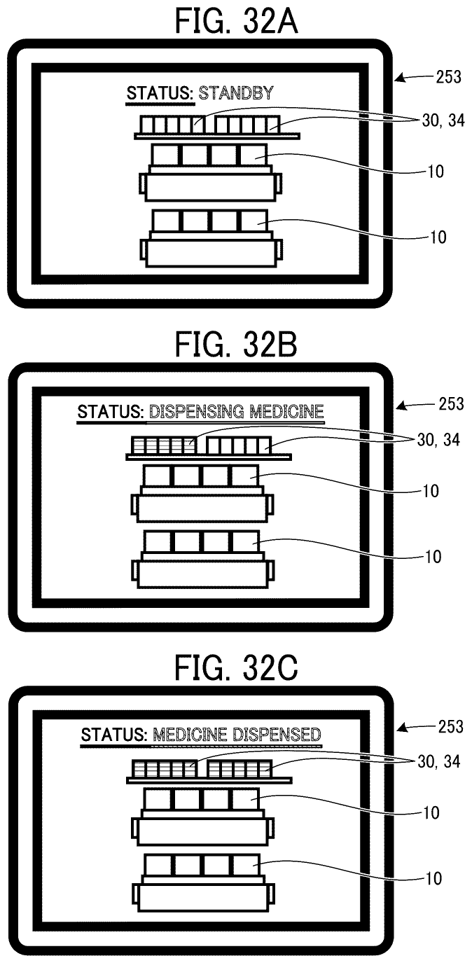

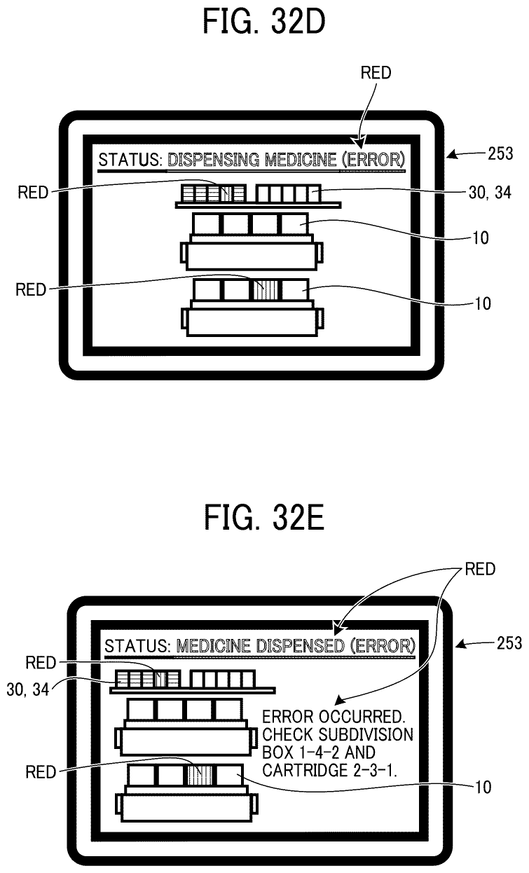

As illustrated in FIG. 32A to FIG. 32E, notification of the current status can be displayed in detail with the monitor 253. As illustrated in FIG. 32A, on the initial screen of the monitor 253, “STATUS: STANDBY” is displayed in green. When a user gives instructions to dispense medicine under the above conditions, as illustrated in FIG. 32B, “STATUS: DISPENSING MEDICINE” is displayed in blue, and the five subdivision boxes 34 on the left in FIG. 32B are indicated in blue.

Under normal operating conditions, as illustrated in FIG. 32C, it is determined that the medicine dispensing operations are complete when the medicine dispensing operations are completed for all the subdivision boxes 34. Moreover, “STATUS: MEDICINE DISPENSED” is displayed in green, and the five subdivision boxes 34 on both the right and left sides in FIG. 32C are indicated in blue. Subsequently, the subdivision box 34 is taken out from the room 33, and the status returns to “STANDBY” as depicted in FIG. 32A.

However, when an error occurs during an operation to pick up a medicine pack, as illustrated in FIG. 32D, “STATUS: DISPENSING MEDICINE” is displayed in blue, and in parallel with that, “ERROR” is displayed in red. For example, the subdivision box 34 to which medicines should have been dispensed and the cartridge 10 from which the medicines should have been picked up are indicated in red to indicate an error, and the next medicine dispensing operation is conducted. When all the medicine dispensing operations are complete, as illustrated in FIG. 32E, both the completion of the medicine dispensing operation and the occurrence of an error are displayed to prompt a user to check the error. Moreover, as illustrated in FIG. 32E, the details of the error “ERROR OCCURRED. CHECK SUBDIVISION BOX: 1-4-2 AND CARTRIDGE: 2-3-1” is indicated in red, and instructions for a user are also displayed.

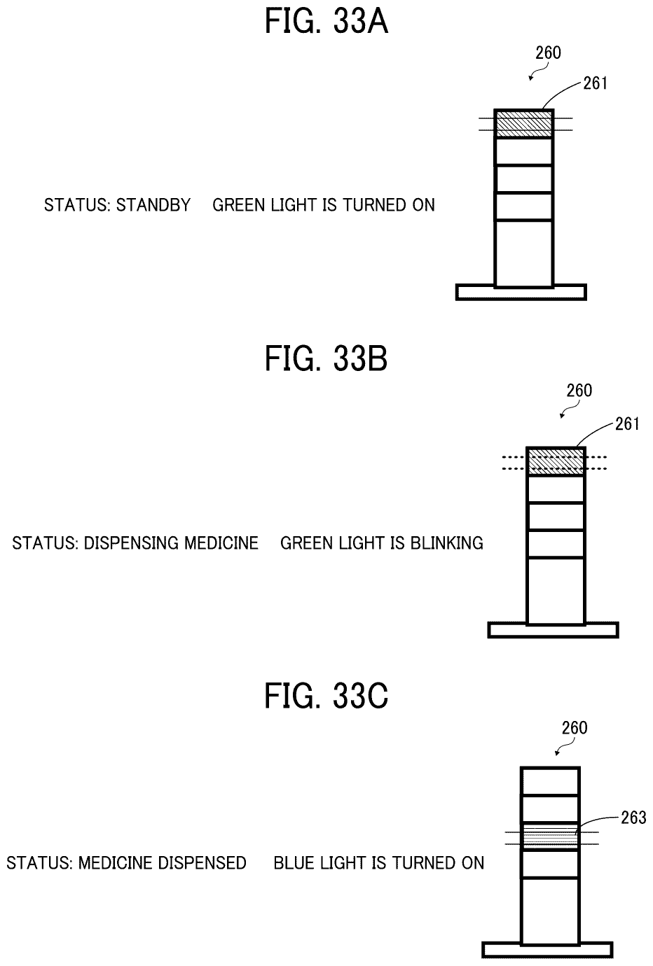

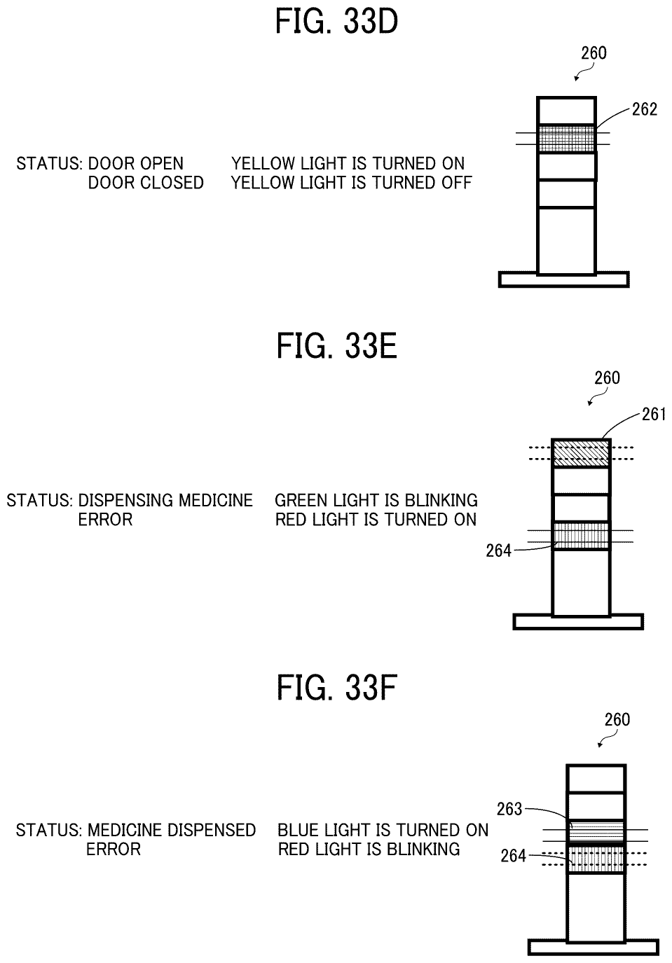

FIG. 33A to FIG. 33F are diagrams each of which illustrates how the status of a device is displayed using a warning light 260.

There are some cases in which the display on the monitor 253 cannot be viewed at a long distance and the status of a device is unknown. In order to handle such a situation, for example, the warning light 260 may be attached to an upper portion of the housing 199 of the medicine dispensing apparatus 200 to display the status of the device.

For example, how the status of the device is displayed using the warning light 260 is as follows. As illustrated in FIG. 33A, when the device is on standby, a green lamp 261 at the top is turned on. As illustrated in FIG. 33B, when the device is dispensing medicine, the green lamp 261 at the top is made blinking to indicate that the device is in operation. The warning light 260 includes several lamps of different colors. The turned-on state of each lamp is indicated by parallel solid lines, and the blinking state of each lamp is indicated by parallel dotted lines.

As illustrated in FIG. 33C, when a blue lamp 263 that is the third lamp from the top is turned on, it indicates the completion of a medicine dispensing operation.

As illustrated in FIG. 33D, the open state of a door is indicated by turning on a yellow lamp 262 that is the second lamp from the top, and the closed state of the door is indicated by turning off the yellow lamp 262.

In the present embodiment, even if an error occurs, the operation is not terminated, and the medicine dispensing operation continues as long as possible. For this reason, when an error occurs, as illustrated in FIG. 33E, the green lamp 261 at the top is made blinking. At the same time, a red lamp 264 at the bottom is turned on to indicate the occurrence of an error.

As illustrated in FIG. 33F, when the medicine dispensing operation is finished to the end, the red lamp 264 is made blinking to prompt a user to check the error.

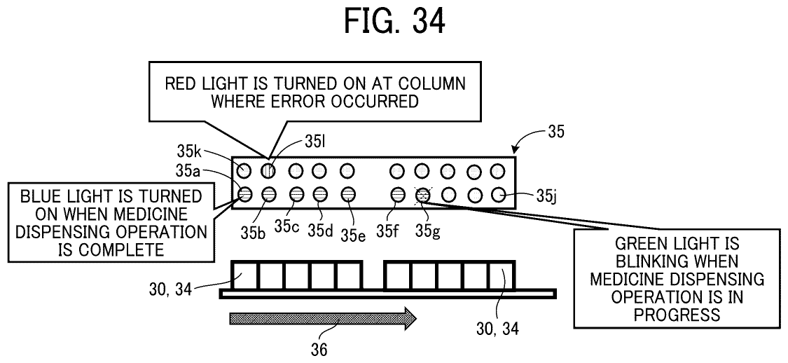

FIG. 34 is a diagram illustrating the arrangement of a group of LEDs 35 to indicate the status of the subdivision boxes 34.

In the above embodiment described with reference to FIG. 32A to FIG. 32E, the point at which an error has occurred is displayed on the monitor 253. Alternatively, like the group of LEDs 35 as illustrated in FIG. 34 to indicate the status of the subdivision boxes 34, display units such as LEDs may directly be added to the columns on the subdivision boxes 34 to physically notify a user of the point at which an error has occurred.

In the group of LEDs 35 that indicate the status of the subdivision boxes 34 as illustrated in FIG. 34, LEDs 35a to LED 35f from the left to the right in the front row, which make up the group of LEDs 35, are turned on to emit blue light when the medicine dispensing operation is completed, and an LED 35g on the right next to the LED 35f is made blinking in blue as indicated by a cross of dotted lines. An LED 351 in the second column that corresponds to a point where an error occurred is turned on to emit a red light. Further, assuming that the medicines are dispensed in an order 36 as indicated by a large arrow, an LED whose function is not to indicate the occurrence of an error may be arranged at a site where the subdivision boxes 34 are arranged in the medicine dispensing tray 30 to provide a function to indicate the completion of a medicine dispensing operation and the progress of the operation.

In a similar manner to the above, an LED or the like may be arranged at the column on the cartridges 10 to indicate an error at the cartridge 10. Due to such a configuration, a user can more intuitively figure out a point to be checked, and the usability increases. This is because it is difficult to check the status on a screen when there are a larger number of subdivision boxes or cartridges. The use of the monitor 253 may be combined with the use of the group of LEDs 35 to indicate the status of the subdivision boxes 34 or the group of LEDs 120 (see FIG. 31A and FIG. 31B) to indicate the status of the cartridges.

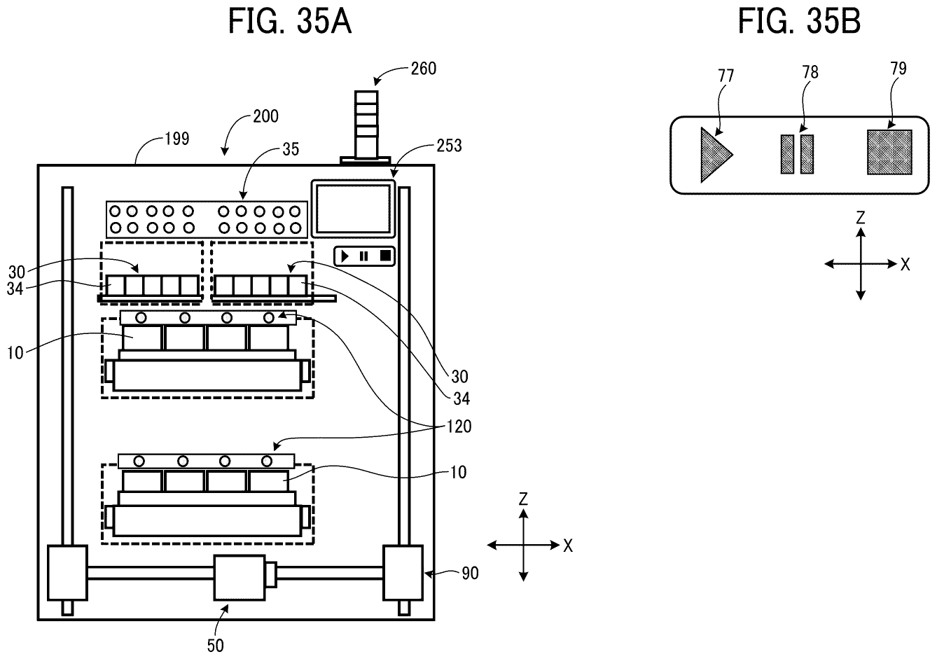

FIG. 35A is a front view of the medicine dispensing apparatus 200.

FIG. 35B is an enlarged view of a site where operation keys to gives instructions to dispense medicine to the medicine dispensing apparatus 200 illustrated in FIG. 35A are arranged.

As illustrated in FIG. 35A and FIG. 35B, the medicine dispensing apparatus 200 is provided with an execution key 77, a pause key 78, and a stop key 79. After a required number of cartridges or cartridge trays and a required number of subdivision boxes are placed in the medicine dispensing apparatus 200, the execution key 77 is touched or clicked to give instructions to dispense medicine to the medicine dispensing apparatus 200. For example, when a medicine pack has to be taken out urgently during the medicine dispensing operation, the pause key 78 is touched or clicked to pause the medicine dispensing operation. After the medicine dispensing operation is paused, for example, the medicine pack can be taken out. As the execution key 77 is touched or clicked again, the medicine dispensing operation resumes.

Alternatively, after a medicine dispensing operation is done, there are some cases in which, for example, a person to which medicine is to be dispensed is mistaken and the entire medicine dispensing operation is to be canceled. In such cases, the entire medicine dispensing operation may be stopped by touching or clicking the stop key 79. Moreover, for example, when the medicine dispensing operation is to be terminated urgently, the medicine dispensing operation may be stopped instantly by touching or clicking the stop key 79.

The above embodiments and examples of the present disclosure described above substantially include, for example, the following aspects.

### First Aspect

A medication support apparatus such as the medication support device 300 includes a container such as the cartridge 10 that stores a plurality of medicine packs such as the multiple medicine packages 2, a medicine dispenser such as the medicine dispensing tray 30 in which specific one of the plurality of medicine packs is disposed at a prescribed position, a picking-up conveyor including a pickup device such as the carriage 50 and a conveyor such as the conveyor 90 to pick up the specific one of the plurality of medicine packs from the container and convey the specific one of the plurality of medicine packs to the prescribed position of the medicine dispenser, a pack data reader such as the medication-related information reader unit 65 disposed on the picking-up conveyor, to read medication-related information added to at least one of the container or the plurality of medicine packs, and medicine-dispensing data added to the medicine dispenser, the medication-related information including a name of a patient who takes medicines and a time of medication, the medicine-dispensing data including the name of the patient who takes the medicines and the time of the medication, a pack data management system such as the pack data management system 212 that manages the medication-related information, and a medicine-dispensing data searching system such as the medicine-dispensing data searching system 230 to search for a combination of the container from which the specific one of the plurality of medicine packs is picked up and the medicine dispenser to which the specific one of the plurality of medicine packs is dispensed, based on the medication-related information read by the pack data reader and the medicine-dispensing data read by the pack data reader. In the medication support apparatus according to the first aspect, based on the combination searched for by the medicine-dispensing data searching system, a medicine dispensing operation is automated.

According to the first aspect, based on the result of reading the medication-related information and the result of reading the medicine-dispensing data, a combination of the container from which the specific one of the plurality of medicine packs is taken out and the medicine dispenser to which the specific one of the plurality of medicine packs is dispensed can be found by the medicine-dispensing data searching system 230. The medicine dispensing operation can be automated based on such a combination for the medicine dispensing operation, and the workload of nurse practitioners or the like can be reduced.

### Second Aspect

In the medication support apparatus according to the first aspect, the medicine dispenser includes a room such as the room used to dispose specific one of the plurality of medicine packs at a prescribed position or a box such as the subdivision box 34A that is attachable to and detachable from the room, and the medicine dispensing operation to the room or the box is automated.

According to the second aspect, the medicine dispensing operation in all the rooms or boxes is automated.

More specifically, the second aspect is as follows. In the first aspect, firstly, a pair of items of medication-related information such as a combination of “A” as the name of a patient who takes medicines and “lunchtime” as the time of medication is read by the medication-related information reader unit 65 including the upper QR code reader 66. More specifically, the medication-related information 6c of the medicine pack, which is attached to the cartridge 10 and indicates, for example, the first row and the column of the first one of the cartridge trays 20 (1-1-1), is read by the medication-related information reader unit 65 including the upper QR code reader 66. Secondly, the medication-related information 6c of the subdivision box 34, which is an example of a box attachable to and detachable from the room 33 of the medicine dispensing tray 30, is read by the medication-related information reader unit 65 including the lower QR code reader 67 as the information related to the time of medication such as “A, lunchtime.” For example, the first row and the column of the first one of the subdivision boxes 34, which is indicated by “1-1-1,” is read by the medication-related information reader unit 65 including the lower QR code reader 67. As described above, the medicine pack that is automatically taken out as the medicine pack for lunchtime from the cartridge 10 is automatically dispensed to the subdivision box 34 indicated by “1-1-1” as the medicine pack for lunchtime.

In other words, in the first aspect, for example, a pair of items of medication-related information such as a combination of the cartridge for Mr. or Ms. A in the morning and the subdivision box for Mr. or Ms. A in the morning is searched for, and the medicine dispensing operation is automatically conducted.

In the second aspect, a pair of items of medication-related information according to first aspect is searched for and medicines are dispensed to, for example, all the subdivision boxes 34 arranged on the medicine dispensing tray 30 with reference to the subdivision boxes 34, based on a combination of the obtained items of medication-related information. What is done in the above operation is as follows. Firstly, the QR codes of all the cartridge trays 20 are read to identify whose medicines are to be dispensed to each cartridge tray 20 at what time. When the QR code on each subdivision box 34 is read, the corresponding cartridge 10 is searched for. Then, the medicine pack 2 is automatically taken out from the cartridge 10 and is dispensed. After the completion of a medicine dispensing operation, the focus shifts to the next subdivision box 34 to read the QR code. Then, in a similar manner to the above, the medicine pack 2 is taken out from the corresponding cartridge 10. This series of operations are automatically repeated for all the arranged subdivision boxes 34.

### Third Aspect

In the medication support apparatus according to the second aspect, when the medication-related information does not match the medicine-dispensing data read by the pack data reader, the medicine dispensing operation is automatically skipped and a next medicine dispensing operation is performed.

According to the third aspect, when the room or the box that corresponds to the subdivision box 34, which is identified by the read medicine-dispensing data, does not match any one of the cartridges 10 that corresponds to the container, the medicine dispensing operation is automatically skipped. Due to such a configuration, medicines can be dispensed to all the sites where there is a match without terminating the operation of the medication support device 300.

### Fourth Aspect

In the medication support apparatus according to the second aspect, when an error occurs during the medicine dispensing operation to pick up the specific one of the plurality of medicine packs, the medicine dispensing operation is automatically skipped and a next medicine dispensing operation is performed.

According to the fourth aspect, when a medicine dispensing operation ends in failure due to, for example, a failure in the suctioning of a medicine pack, medicine dispensing steps are skipped. Accordingly, medicine dispensing operations are thoroughly done wherever possible without terminating the operation of the medication support device 300. Due to such a configuration, what has to be done can collectively be dealt with in the end, and the efficiency increases.

### Fifth Aspect

In the medication support apparatus according to the second aspect, a user is notified of a location of the room or the box of the medicine dispenser with an error.

According to the fifth aspect, a user is notified of the location of the room or the box that corresponds to the subdivision box 34, where an error has occurred, through an LED or the like. Due to such a configuration, an error can instantly be recognized, and treatment can be given appropriately.

### Sixth Aspect

In the medication support apparatus according to the second aspect, a user is notified of a location of the container with an error.

According to the sixth aspect, a user is notified of the location of the container with an error through an LED or the like. Due to such a configuration, an error can instantly be recognized, and treatment can be given appropriately.

### Seventh Aspect

In the medication support apparatus according to the second aspect, a user is notified of a location of the room or the box of the medicine dispenser where the medicine dispensing operation is being performed.

According to the seventh aspect, a user is notified of the site in which the medicine dispensing operation is being performed.

### Eighth Aspect

In the medication support apparatus according to the second aspect, a user is notified of a location of the room or the box where the medicine dispensing operation is complete.

According to the eighth aspect, a medicine dispensing operation is sequentially conducted with respect to the medicine dispenser such as the medicine dispensing tray 30. Due to such a configuration, a site where a medicine dispensing operation is complete is indicated, and the progress of the operation can roughly be observed.

### Ninth Aspect

In the medication support apparatus according to the second aspect, the medicine dispensing operation is temporarily paused.

According to the ninth aspect, for example, when it is urgent and a medicine pack is to be taken out manually during a medicine dispensing operation, the medicine dispensing operation can be paused.

### Tenth Aspect

In the medication support apparatus according to the second aspect, the medicine dispensing operation is terminated and cancelled.

According to the tenth aspect, a medicine dispensing operation can be stopped at some midpoint when some sort of a malfunction or error occurs due to, for example, an error in placement after a medicine dispensing operation is done.

### Eleventh Aspect

In the medication support apparatus according to the second aspect, unloading of the container is detected, and the information is read only when the information is to be checked again.

According to the eleventh aspect, after the QR code on the container such as the cartridge 10 is once read, an attempt to read the QR code is not made again unless the cartridge tray 20 is pulled out. Accordingly, the productivity increases.

### Twelfth Aspect

In the medication support apparatus according to the second aspect, a user is notified that the medicine dispensing operation is complete.

According to the twelfth aspect, the completion of a medicine dispensing operation is indicated, and a user can know the timings at which the medicine dispensing tray or the subdivision box can be taken out.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application-specific integrated circuit (ASIC), digital signal processor (DSP), field-programmable gate array (FPGA), and conventional circuit components arranged to perform the recited functions.

What is claimed is:

1. A medication support apparatus comprising:
a container to store a plurality of medicine packs;
a medicine dispenser in which a specific one of the plurality of medicine packs is disposed at a prescribed position;
a picking-up conveyor to pick up the specific one of the plurality of medicine packs from the container and convey the specific one of the plurality of medicine packs to the prescribed position of the medicine dispenser;
a pack data reader disposed on the picking-up conveyor, to read medication-related information added to at least one of the container or the plurality of medicine packs and medicine-dispensing data added to the medicine dispenser, the medication-related information including a name of a patient who takes medicines and a time of medication, the medicine-dispensing data including the name of the patient who takes the medicines and the time of the medication; and
processing circuitry configured to
manage the medication-related information,
manage the medicine-dispensing data,
search for a combination of the container from which the specific one of the plurality of medicine packs is picked up and the medicine dispenser to which the specific one of the plurality of medicine packs is dispensed, based on the medication-related information read by the pack data reader and the medicine-dispensing data read by the pack data reader, and
automate a medicine dispensing operation based on the combination.

2. The medication support apparatus according to claim 1,
wherein the medicine dispenser includes a room used to dispose the specific one of the plurality of medicine packs at the prescribed position or a box attachable to and detachable from the room, and
wherein the processing circuitry automates the medicine dispensing operation in the room or the box.

3. The medication support apparatus according to claim 2,
wherein, when the medication-related information does not match the medicine-dispensing data read by the pack data reader, the processing circuitry skips the medicine dispensing operation automatically and performs a next medicine dispensing operation.

4. The medication support apparatus according to claim 2,
wherein, when an error occurs during the medicine dispensing operation to pick up the specific one of the plurality of medicine packs, the processing circuitry skips the medicine dispensing operation automatically and performs a next medicine dispensing operation is performed.

5. The medication support apparatus according to claim 2,
wherein the processing circuitry indicates a location of the room or the box of the medicine dispenser with an error.

6. The medication support apparatus according to claim 2,
wherein the processing circuitry indicates a location of the container with an error.

7. The medication support apparatus according to claim 2,
wherein the processing circuitry indicates a location of the room or the box of the medicine dispenser where the medicine dispensing operation is being performed.

8. The medication support apparatus according to claim 2,
wherein the processing circuitry indicates a location of the room or the box where the medicine dispensing operation is complete.

9. The medication support apparatus according to claim 2,
wherein the processing circuitry temporarily pauses the medicine dispensing operation.

10. The medication support apparatus according to claim 2,
wherein the processing circuitry terminates and cancels the medicine dispensing operation.

11. The medication support apparatus according to claim 2, further comprising
a sensor to detect unloading of the container,
wherein the processing circuitry controls the pack data reader to read the medication-related information only when the unloading of the container is detected by the sensor and the medication-related information is to be checked again.

12. The medication support apparatus according to claim 2,
wherein the processing circuitry indicates completion of the medicine dispensing operation.
